(19) United States
(12) Patent Application Publication
(10) Pub. No.: US 2025/0303850 A1
(43) Pub. Date: Oct. 2, 2025

(54) Gyroscopic Motion Machine

(71) Applicant: Walter E. Wood, Sylvester, GA (US)

(72) Inventor: Walter E. Wood, Sylvester, GA (US)

(21) Appl. No.: 19/067,899

(22) Filed: Mar. 1, 2025

Related U.S. Application Data
(63) Continuation-in-part of application No. 13/886,257, filed on May 2, 2013.
(60) Provisional application No. 61/641,372, filed on May 2, 2012.

(51) Int. Cl. B60K 8/00

(52) U.S. Cl. CPC B60K 8/00

(57) ABSTRACT

A gyroscopic apparatus, having application as a prime mover, has a pair, or alternatively multiple pairs, of flywheels disposed opposite one another. A pivot axis of the flywheels lies in a position midway between the flywheels for each pair. Each flywheel has its own separate electric motor or engine. A drive arrangement operates to spin the assembly unit about a second axis in the same plane, but perpendicular to the flywheel pair axis.

### PRIORITY CLAIM

The present application claims priority and benefit of U.S. Provisional Application No. 61/641,372 filed on May 2, 2012. The present application is a continuation-in- part of U.S. Nonprovisional application Ser. No. 13/886,257 filed on May 2, 2013.

### FIELD OF THE INVENTION

The present invention provides a gyroscopic motion machine, in particular a gyro apparatus having application as a prime mover.

### BACKGROUND OF THE INVENTION

Previous efforts have established the use of gyroscopic devices having application as prime movers. U.S. Pat. No. 5,024,112 to Kidd discloses a gyroscopic apparatus as a prime mover, with a pair of discs disposed opposite one another with arms rotatable supporting the discs. The gyro rotation of the two flywheels (only 1 pair of gyro flywheels) is demonstrated by the U.S. Pat. No. 5,024,112. However, the method is very complicated. Both the flywheel and the assembly for rotation is accomplished by belts, gears, and pulleys. A very complicated mechanism does this with a single drive motor. While the direction of the rotation of the flywheels and the assembly seems to be correct, the mechanism utilizes lever arms for a back and forth motion upon the flywheels, which is suggested to add to the reaction force.

U.S. Pat. No. 5,090,260 provides a gyro motion machine of a different type and provides a different direction of rotation to that which is desirable presently. The '260 gyro is not believed useful for the purposes disclosed herein.

Friction and drag decrease efficiency, and a need exists for a gyro unit that can be used as the prime mover for craft and vehicles of all types. A further need exists for a gyro machine that is simple in design, efficient, and easy to scale in several ways for increased reaction force.

### SUMMARY OF THE INVENTION

The flywheels for this gyroscopic motion machine are directly coupled to motors or engines in the direct vicinity of the flywheel. The flywheels are mounted and rotate inside of a double disk assembly wheel. The electrical power source or fuel is delivered to the flywheel driver motors or engines. For a simple smaller unit, onboard batteries inside the assembly wheel can be utilized as the power supply for the gyro flywheel motors, with either batteries or 120 VAC power for the drive motor. For larger electrical units, a suitable power source such as 120 VAC or higher can be used for all motors. The gyro flywheel motor can also be a DC motor type. For engine driven flywheels, a fuel tank can be mounted inside the assembly wheel for a simple unit. Other delivery systems for electrical power or fuel are included within this design group. Other power systems such as air, vacuum or steam for turbine drives are also included within the scope of this invention. The gyroscopic motion machine assembly wheel units are additive to provide a choice of multiple gyro motor and flywheel pairs because of the individual component design of the multi-component assembly wheel unit. Each flywheel pair is mounted inside a component section. Several components are assembled into one unit and are driven by a single drive motor unit.

The gyro motion unit moves in any direction, and it moves with force. The force is generated by the rotation of gyro flywheels within a disk assembly. First, the individual flywheels within each flywheel pair are started spinning at a constant speed for the potential gyro energy. A unit assembly which contains one or more flywheel pairs (“gyro assembly wheel unit”) is then rotated, producing a reaction force that causes motion. The resistance of the unit assembly to this rotation is proportional to the combined stored rotational energy of each gyro flywheel and the rotational speed of the gyro assembly wheel unit. This resistance to the turning of the unit assembly produces a reaction force.

The gyro flywheels are individually rotated by electric motors or engine type motors. The gyro flywheels are mounted in a double disk type “gyro assembly wheel unit.” Other shapes such as ovals can be used for the assembly unit sides. A simple containment of the gyro flywheels and bearings, with a shaft, completes the unit assembly.

Motor drivers (e.g. electric or fuel type engines) drive each flywheel. The diametrical design requires that each flywheel pair has one counter clockwise flywheel and one clockwise flywheel for the reaction force to occur, positioned exactly opposite or 180 degrees apart. Fuel unit and electric driven flywheels will be reversed in rotational direction. The electrical leads would be reversed for a DC motor. Engines are configured to act rotationally opposite each other on start-up. This is possible for small and simple model engines. (Larger 2 cycle UAV engines can be ordered and purchased CCW or CW for the larger sizes.) This allows a perfectly balanced, symmetrical and diametrical design for the gyro assembly flywheel pairs. For the pair, the flywheels and motors are required to be diametrical. Larger engines can be built that would run in either direction clockwise or counter clockwise, and are expected to be 2 cycle type engines. The 2 cycles are lighter weight also. A pulley and belt, gear to gear, or chain and sprocket system can be utilized for the assembly wheel unit drive. Gear drives will require oiling and housing with seals for good machine life. Therefore an off the shelf gear motor set can be used for the assembly wheel unit drive. All of these methods for the drive system are claimed by this document, even though only the pulley and belt drive system is shown completely. A simple conversion is an obvious variation.

The assembly wheel unit is rotated by an additional electric motor or engine. One assembly wheel unit, with a pair of gyro flywheels mounted inside, and a craft frame is a simple complete unit for motion.

This unit is additive for multiple gyro flywheel pairs due to the individual component design of the assembly wheel. The positions of the gyro flywheel pairs can be made in two ways. One is done by rows and another way is by simply making the assembly disk wheel larger for more room for gyros motors and flywheels. Both cases provide equal spacing and are symmetrical in design. Also the gyro motors and flywheel pairs are diametrical.

Multiple pairs can be utilized to increase the total reaction force. For multiple pairs of gyro flywheels, a stacked row arrangement can be used for a normal size gyro disk wheel. A special and sequential order is required for the rotational positions. Another very good arrangement is for all the gyro flywheel pairs to be lined up in multiple rows in the gyro assembly wheel unit. Again the gyro motors and flywheel pairs are diametrical.

For multiple sets of gyro flywheel pairs, another arrangement is equal spacing in an angular placement of the gyros within the gyro assembly wheel. For this arrangement, a larger disk for the assembly wheel is required. Again the gyro motors and flywheel pairs are diametrical.

In all of the above cases with multiple additional gyro pairs mounted in a unit assembly, the assembly unit has a single drive motor system including one motor, one shaft, one set of drive pulleys, etc.

For the assembly wheel, the maximum precession speed must not be exceeded; or a pulse force will be the result, with only a partial reaction force (a percentage). This could be expressed as a time duration effect, and a percentage factor would need to be applied to compensate for the pulse force. Keeping the drive speed of the assembly wheel slow enough for a 100% reaction force is critical for the best performance. It is desirable for the reaction force to be continual, without pulsing. Of course, this applies to the drive motor unit or the third motor unit. It could be a gear motor or a standard motor, with additional gear down provided. In addition a VFD (variable frequency drive) speed controller can be provided on the slow side. The drive speed can be controlled from zero to the maximum, which is the precession speed. Therefore, the resultant reaction force can be modulated by optimizing the RPM (revolutions per minute) speed of the drive motor unit.

For a reasonable and uniform force direction, and to minimize complications, it is important to cause all of the gyro flywheels to rotate at the same speed; this creates a balanced reaction force. For a symmetrical, diametrical, and balanced arrangement, the resultant force is at the exact center of the assembly wheel disk, and is perfectly perpendicular to the disk for each assembly wheel unit. The resultant force is parallel with the gyro assembly unit shaft, and for a perfectly constructed unit, is located in the exact center of the shaft and can be transmitted through the thrust component of the gyro assembly wheel bearings to the frame of the unit. The resultant force obeys a right handed rule for its direction. (When the fingers of the right hand curl and point in the direction of the assembly wheel rotation, then the thumb points in the direction of the force.)

There are two ways to deliver the input power (the power to spin both of the flywheels inside the gyro assembly.) A first way is for the unit to have its fuel or batteries mounted inside the gyro assembly wheel unit. Then a simple supply of power is an easy transfer. A second way is for the unit to have an electric power cord or a fuel line, either for electric motors or combustion engines. Some special fittings are required to deliver the fuel or electric power to the gyro flywheel driver (motor or engine) when the assembly wheel unit is rotating.

Bronze washer-like rings for electrical current delivery are required for utilizing typical motor type brushes. One outer ring and one inner ring is mounted on one disk. Two different sized rings and separation are required. Alternately rings of the same size diameter could be mounted on the two disks, one on each end.

A swivel joint can allow a supply of fuel to be piped into the assembly wheel. A fuel delivery system can be utilized by using a swivel joint on the disk to allow the fuel to be delivered to the engine. A hollow shaft permits delivery to the inside of assembly wheel for distribution. On the outside of the shaft, a swivel joint makes connection to the fuel lines for a supply and return type of piping system. Two swivel joints are required, one on each end of the assembly wheel central shaft.

For ground units, normal steering can be utilized, such as turning the front tires with a traditional steering wheel system, but also directional gyro forces are possible. This is done by turning the gyro assembly in a specific direction and coordinating with the vehicle front wheels. (Either by turning the front wheels simultaneously or allowing them to be free to swivel/turn and follow the direction of the gyro force, or alternately allowing the rear tires to swivel freely with the front tires set straight.) By applying very good directional controls, the dangers of snow and ice travel should almost be totally eliminated, since traction becomes much less of an issue. Forward and directional motion would be controlled for an exact position and not dependent on traction of the tires. Normal wheel-type brakes are needed as a backup system only, since reversing the gyro assembly would very effectively apply brakes, by applying an opposite force. The forward and reverse forces can also be modulated up or down, by the speed of the gyro assembly wheel unit. There is a slight delay to stop and reverse the gyro assembly wheel unit and to get the unit rotating in the opposite rotational direction to apply a braking or reverse force to the vehicle or craft. There is not necessarily a correlation of gyro and vehicle speed with its tire rotation speed. A simple force is applied for acceleration of the vehicle and is related to the gyro assembly wheel speed. For coasting the gyro assembly wheel unit is stopped. Therefore, no force is applied.

For special units, special cart wheels can be utilized for better maneuverability. All four wheels would turn when the gyro assembly is turned and the directional force applied, and the cart would move sideways. The cart wheels can be freewheeling for easy turning.

Bearing members, such as rollers can be added on the outside edge of the flywheels and are included in a design group that restrains excessive wobble. Roller arrangements include the flywheel rollers with outside sleeves, and other variations. These additional parts act as bearings to prevent excessive movement of the weighty flywheels when the assembly wheel speed is changed or stopped and reversed. These include two types of rollers: flat roller and spherical rollers. A special trough is used as a guide with the spherical rollers. A regular sleeve is used for the flat roller. Special skid knobs with sleeves are also included. Rollers can be made of rubber or hard plastic, nylon, or even steel. In addition, outside bearings are included to serve the same function with or without a coupling to the motor shaft (depending on the motor shaft length.) Similarly, separate outside bearings are included for units which have flywheels on a single shaft. These last two are equal in merit in regards to stability, but are very different designs.

In lieu of the above-described rollers and guides, magnetic bearings can be utilized. These bearings provide air gaps for complete friction-free rotation, and also can prevent wobble when a larger size is used. Magnetic bearings can also be used in lieu of regular bearings, and are fitted to match the shaft diameter. They can also replace the normal bearings on the gyro assembly wheel unit. They are also available for thrust, and can be utilized on each end of the assembly wheel unit and for the flywheel if desired.

One merit of a magnetic coupling is that the resultant RPM speed can be controlled. Therefore when magnetic couplings are utilized, the force can be modulated with speed control for the gyro assembly wheel unit.

Optional methods can be used to power flywheel rotation. A vacuum can be utilized with a turbine wheel on each flywheel. Similarly, an air turbine system can be utilized, with air compressors providing pressurized air. A supply line swivel joint connection is all that is needed for vacuum and pressurized air systems. Similarly a steam turbine system can be used, very similar to a normal steam turbine. All of these optional methods require a specialized fitting connection to the gyro assembly from the tanks and pumps, which are mounted on the exterior framing. A swivel joint is a fitting that allows swivel on one side of the supply line. The swivel joint is typically connected to a hollow shaft. The swivel joint fittings can also be used for the turbine supply or return piping. In addition, they can be used for supply and return for hydraulic type motors.

For a shift in the resultant force direction (to turn the gyro reaction force to a different direction), the gyro assembly can be mounted on a swivel to allow a rotation. (A maximum of 180 degrees is practical and possible.) With a reversing motor for the assembly, a reverse force would allow complete directional flexibility in combination with above for a 360-degree directional reaction force. (A 180-degree rotation is required for the gyro unit.) The mechanism to turn the assembly can be motorized or turned by hand. This could be utilized for ground or marine units.

For light weight construction, an alternate construction for the gyro flywheel involves normal spokes and rim wheels with a normal connection to the motor shaft. Flywheel weights are attached to the rim. Also, the flywheel disk type can be drilled with large and small holes to minimize the interior weight of the flywheel. (Weight for the gyro's flywheel should always be applied to the outer part of the flywheel.) These are obvious engineering principles for flywheel and angular momentum equations for factors such as radius of gyration, etc. However the designs and claims are included for this unit for the maximum reaction force due to the gyroscopic resistance. Therefore these designs cover this principle.

Engine driven flywheels can be used as an alternate. On-board fuel tanks can be used, mounted inside the assembly wheel. The position can be 90 and 270 degrees staggered away from the gyro flywheels to help with the dynamic balancing. In this way, the endurance of the bearings for the assembly is improved, because a more even distribution of weight is placed around the disk.

A VFD (Variable Frequency Drive) controller can be used to change the speed of the driver motor units for the gyro assembly wheel. Tilting sensors can be used in connection with the VFD controller. The controller changes each gyro assembly drive motor, in accordance with settings, etc. A pilot inputs the desired directions. Alternately, a magnetic coupling is used between two shafts that drive the assembly wheel. In both cases, the drive motor can be reversed for a reversed directional reaction force.

Some embankment for turning can be incorporated utilizing banking control on each side, such as a controller with adjusting lifters or shocks on each side. In another object of the invention, stabilizer type gyro units can be utilized for tractor trailer overturning prevention. (See FIG. 25.)

An object of the present mechanical gyro unit is to provide an energy input that is nearly equal to the energy out, with only a slight bearing loss for friction. Therefore, almost all resistance is converted into a useable reaction force. The resistance of rotation is due to the energized gyro flywheels. The force is a pure reaction force. A pure resultant force is produced by the unit, on the framing, at the center of the assembly wheel disk at the thrust bearings.

Another object is to use the present gyro unit with an external power system. A well designed electric power and/or fuel delivery systems such as trolley car type power rail systems, could be used for all the crafts.

Still another object is to use on-board fuel delivery and storage tank systems for engine driven units. A unit can utilize small generators to allow some of the gyro unit motors to remain electric.

External bearings outside the flywheel can allow additional flywheel weight, and also allows a larger flywheel diameter and prevents wobble or out-of-place positioning. (See FIG. 24)

For flywheel repositioning inside an assembly wheel, a screw type mechanism can be utilized. (See FIGS. 21A, 21B, 21C, 26A and 26B.)

A combination engine with fuel tanks, DC generator, and DC electric motor driven flywheels can be utilized. The engine can be an off the shelf UAV (Unmanned Aerial Vehicle) engine unit, or custom built for the larger sizes. The UAV engines are generally two cycle type engines. A magnetic type coupling can be utilized.

A rubber wheel drive system, similar to an older snapper mower type drive system, can be utilized for the assembly wheel drive system, especially for small gyro assemblies. The rubber drive wheel can be positioned onto the disk assembly by pressure with a spring mechanism. The exact position can be adjusted to a more outer radius for more gear down or to an inner radius for a higher speed. An alternate and more powerful frame mounted motor is also shown for the rubber wheel drive that allows a solenoid to turn the unit on and off by engaging the rubber wheel with a lever. The radius position can be reset manually, but can be made automatic by a splined shaft and other lever mechanisms for a motorized movement for speed control on the fly. This would be an improvement from what is shown in the figures. What is shown is a manually speed adjustment design, where the position of both the motor and the rubber wheel is moved manually and equally. (See FIGS. 20 and 27.)

### BRIEF DESCRIPTION OF THE FIGURES

FIG. 1 (GYRO CART) is an isometric view of an illustrative gyroscopic motion machine in accordance with an embodiment of the present invention.

FIG. 1A is an enlarged end view of a flywheel of the machine.

FIG. 1B is an enlarged isometric view to show the gyro assembly internal components.

FIG. 1C is an enlarged isometric view to show the motor's mounting clamp.

FIG. 1D (PARTIAL) is an enlarged sectional view of a flywheel and shaft assembly of the machine shown in FIG. 1A.

FIG. 2 (GYRO CART) is an isometric view of one embodiment of a steering mechanism connected to a gyroscopic motion machine.

FIG. 2A is an enlarged isometric view to show item 2A of FIG. 2, the motor's mounting clamp.

FIG. 2B is an enlarged isometric view of item 2B of FIG. 2 to show the steering pulley and the steering motor.

FIG. 2C is an isometric view to show a lift block.

FIG. 3 (ASSEMBLY WHEEL COMPONENT) is an isometric view of an alternative configuration of the gyroscopic motion machine in accordance with the invention.

FIG. 3A is an enlarged isometric view to show the motor's mounting clamp.

FIG. 3B is a cut away end view of along line 3B of FIG. 3 illustrating the alternative arrangement of flywheel pairs.

FIG. 4 (ASSEMBLY WHEEL UNIT) is a front end view of a disk of an assembly wheel for electrical current delivery inside the component used in the gyro motion machine.

FIG. 4A is an enlarged cut-away sectional view of FIG. 4 along line 4A.

FIG. 4B is a further enlarged cutaway view of the attachment device indicated as item 25 in FIG. 4A.

FIG. 5 (ASSEMBLY WHEEL UNIT) is an end view of an assembly wheel of the illustrative gyroscopic motion machine showing a swivel joint and hollow shaft mechanism for the delivery of fuel.

FIG. 5A is a cut-away sectional view of FIG. 5 along line 5A.

FIG. 6 is an isometric view of one embodiment of an assembly wheel component of the gyroscopic motion machine with engines and fuel tanks.

FIG. 6A is an enlarged end sectional view of FIG. 6 along line 6A with engines and fuel tanks (assembly wheel component), and illustrates an alternative flywheel drive system with glow plug type engines arranged with respect to an assembly wheel used in the gyroscopic motion machine.

FIG. 7 (ASSEMBLY WHEEL COMPONENT) is an end view of an alternative turbine drive flywheel to be used in the gyroscopic motion machine.

FIG. 7A is a cut-away view along line 7A of FIG. 7.

FIG. 7B is a cut-away view along line 7B of FIG. 7.

FIG. 8 is an end view of an exemplary flywheel design with accessories used in the gyroscopic motion machine to prevent wobble.

FIG. 8A is a cut-away view along line 8A of FIG. 8.

FIG. 8B is an enlarged cut-away view along line 8B of FIG. 8.

FIG. 8C is an enlarged sectional view along line 8C to show the roller of FIG. 8.

FIG. 9 is an end view of an exemplary flywheel design with accessories to improve stability.

FIG. 9A is an enlarged cut-away view along line 9A of FIG. 9.

FIG. 9B is a cut-away view along line 9B of FIG. 9.

FIG. 10 (ASSEMBLY WHEEL COMPONENT) is an isometric view of an exemplary assembly with one electric motor for a pair of flywheels in the gyroscopic motion machine.

FIG. 10A is a cut-away view along line 10A of FIG. 10.

FIG. 10B is an enlarged isometric view of item 166 in FIG. 10A, the motor's mounting clamp.

FIG. 11 (ASSEMBLY WHEEL COMPONENT) is an isometric view of an alternative assembly with one electric motor for a pair of flywheels of the gyroscopic motion machine.

FIG. 11A is a cut-away view along line 11A of FIG. 11.

FIG. 11B is a cut-away view along line 11B of FIG. 11.

FIG. 11C is an enlarged isometric view of item 166 in FIG. 11A and FIG. 11B, the motor's mounting clamp.

FIG. 12 (GYRO CART) is an isometric view of an alternative embodiment of a gyroscopic motion machine with magnetic coupling.

FIG. 12A is an enlarged isometric view of the motor's mounting clamp of FIG. 12.

FIG. 13 (GYRO UNIT) is an isometric view of an alternative gyro unit incorporating a flywheel with magnetic external bearings.

FIG. 13A is an enlarged isometric view of the motor's mounting clamp of FIG. 13.

FIG. 14 is an end view of an alternative embodiment of a flywheel used in the gyroscopic motion machine.

FIG. 14A is a cut-away view along line 14A of FIG. 14.

FIG. 15 is an end view of an alternative embodiment of a flywheel used in the gyroscopic motion machine.

FIG. 15A is a cut-away view along line 15A of FIG. 15.

FIG. 16 is an end view of another alternate flywheel design with accessories to prevent wobble, for use in the gyroscopic motion machine.

FIG. 17 (GEAR DRIVE) is a side view of a gear arrangement for turning a gyroscopic unit of a gyroscopic motion machine, for changing directional movement.

FIG. 18 (ASSEMBLY WHEEL COMPONENT) is an end view of an alternative assembly of a double ended engine driver for a pair of flywheels in the gyroscopic motion machine that is an alternative to the driver shown in FIG. 10.

FIG. 18A is an enlarged end sectional view of FIG. 18 along line 18A with engines and fuel tanks

FIG. 19 is an isometric view of an alternative flywheel configuration for a gyroscopic unit.

FIG. 20 (GYRO CART) is an isometric view of an alternative gyroscopic motion machine in accordance with the invention, with rubber wheel drives for the disk assembly wheel to be used for smaller applications.

FIG. 20A is an enlarged isometric view of the motor's mounting clamp.

FIG. 21A (ASSEMBLY WHEEL COMPONENT) is an isometric view of an alternative variable radius gyro flywheel gyroscopic unit of the gyroscopic motion machine arranged according to an embodiment for movement of the flywheels and the motor to manipulate the reaction force of the unit.

FIG. 21B is a cut-away sectional view along line 21B of FIG. 21D showing a position of the flywheels and motor.

FIG. 21C (ALTERNATE MOTOR LOCATION) is a cut-away sectional view of a gyroscopic unit like that in FIG. 21A, showing a position of the flywheels and an alternative motor position.

FIG. 21D is a cut-away sectional view along line 21D of FIG. 21A showing a position of the flywheels and motor.

FIG. 21E is an enlarged isometric view of item 21E of FIG. 21C and FIG. 21D to show the limit switch.

FIG. 21F is an enlarged isometric view of item 21F of FIG. 21C and FIG. 21D to show the motor's mounting clamp.

FIG. 21G is an enlarged cutaway view of a connecting rod which connects the gyro assembly disks in the locations shown on FIG. 21C and FIG. 21D, item 124.

FIG. 22 is a schematic wiring diagram for an 18 DC volt system for a toy model assembly wheel and cart unit using the gyroscopic motion machine of the invention.

FIG. 23 (GYRO UNIT) is an isometric view of a gyroscopic assembly wheel unit of a machine in accordance with an embodiment of the invention including additional weights offset from the location of the flywheels.

FIG. 23A is an enlarged isometric view of item 1 of FIG. 23 to show the motor's mounting clamp.

FIG. 24 (GYRO UNIT) is an isometric view of a gyroscopic assembly wheel unit of a machine in accordance with an embodiment of the invention including additional bearings and shaft couplings for maintaining a stabilized flywheel position for starting and stopping of the gyro assembly wheel unit.

FIG. 24A is an enlarged isometric view of item 1 of FIG. 24 to show the motor's mounting clamp.

FIG. 25 (GYRO STABILIZER) is an isometric view of truck trailer mounted gyro stabilizer units for the prevention of overturning during high speed turns. The gyro assembly drive motors are reversible, to provide left or right turn assistance for the tall and loaded trailer.

FIG. 25A (GYRO STABILIZER) is an enlarged isometric view of item 138 of FIG. 35 to show the gyro assembly internal components.

FIG. 25B is an enlarged isometric view of item 1 of FIG. 25A to show the motor's mounting clamp.

FIG. 26A (ASSEMBLY WHEEL COMPONENT) is an isometric view of an alternate gyroscopic unit of the gyroscopic motion machine arranged according to a variable radius embodiment for movement of the flywheels and the motor to manipulate the reaction force of the unit. A straight tube or rod and concave rollers are utilized.

FIG. 26B is a cut-away sectional view along line 26B of FIG. 26C showing the position of the flywheels and motor.

FIG. 26C is a cut-away sectional view along line 26C of FIG. 26A showing a position of the flywheels and motor.

FIG. 26D is an enlarged isometric view to show the motor's mounting clamp.

FIG. 26E is an enlarged end view to show the limit switch.

FIG. 26F is an enlarged cutaway view of item 124 shown in FIG. 26C, the area where connecting rods attach to each disk.

FIG. 27 (GYRO UNIT) is an isometric view of a gyro assembly similar to FIG. 20, but with an automated and improved motor mounting design with an improved location for the on/off engagement mechanism.

FIG. 27A is an enlarged isometric view of area 27A of FIG. 27 to show the solenoid motor and swivel connection joint.

FIG. 27B is an enlarged isometric view of item 150 of FIG. 27 to show the bearing and snap ring on the pressure lever.

FIG. 27C is an enlarged isometric view to show an alternative for a manual mechanism for the pressure lever.

FIG. 27D is an enlarged isometric view of item 27D of FIG. 27 to show the motor's mounting clamp.

FIG. 28 (ASSEMBLY WHEEL COMPONENT) is an end view illustrative of an alternative hydraulic motor driven flywheel used in the gyroscopic motion machine.

FIG. 28A is a cut-away sectional view along line 28A of FIG. 28.

FIG. 28B is a cut-away sectional view along line 28B of FIG. 28.

FIG. 29 (GYRO CART) is an isometric view of a multi-gyro component set (each with multiple pairs) packaged as a unit, arranged in a straight line row. Each pair will be additive for an accumulative reaction force.

FIG. 29A is an enlarged isometric view of item 1 of FIG. 29 to show the motor's mounting clamp.

### DETAILED DESCRIPTION OF THE INVENTION

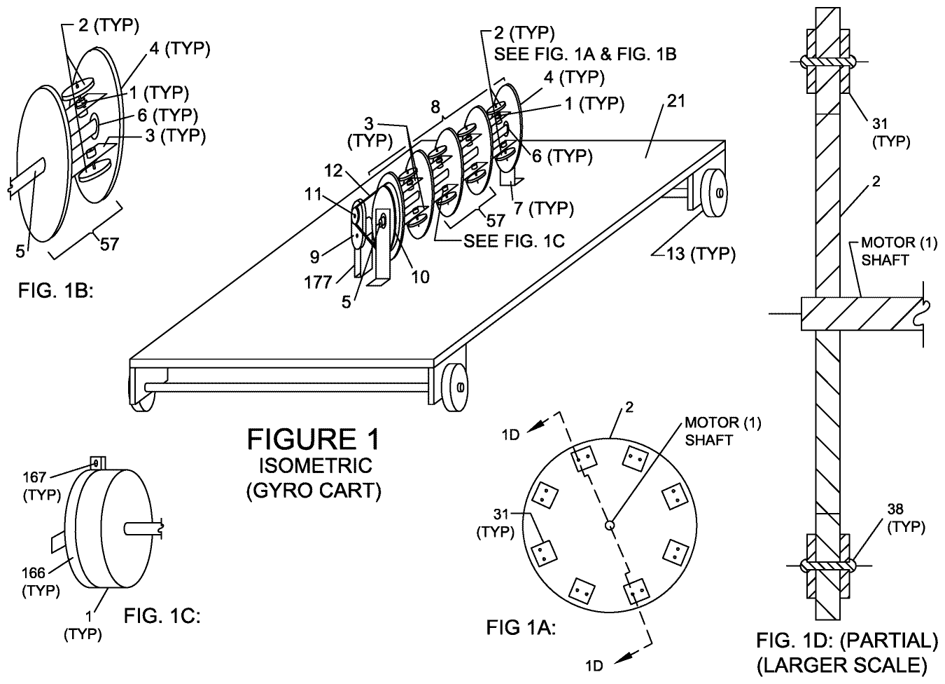

Referring now to the drawings and in particular to FIG. 1, the gyroscopic motion machine includes at least one unit that has a gyro electric motor (1) and a flywheel pair (2). The flywheel pair includes a first flywheel and a second flywheel positioned opposite each other, at 0 and 180-degree (on startup) that will be mounted with the cross bracing (3) and spacer for typically two or more disks components (4), also referred to herein as disks (4), to mount into the gyro assembly wheel (8), also referred to herein as the assembly wheel unit (8). The disks (4) are spaced in parallel spaced relation in uniform position with no offset and define a space in which one or more flywheel pairs (2) are sandwiched or situated between and inside of the space between a pair of disks (4). This unit detail is for horizontal motion where the assembly wheel unit is situated horizontal with the disks (4) being vertically disposed on a horizontal shaft (5). The gyro assembly wheel (8) is mounted on a cart frame (21) to demonstrate an exemplary embodiment of the machine. The flywheels of the flywheel pair (2) are directly coupled to the first and second motors (1) for clockwise and counterclockwise rotation. The motor shaft may have a threaded connection or other method for connecting the flywheel. The assembly wheel (8) can be different shapes such as an oval but will hold the pairs of gyro flywheels and motors in place. Also the assembly wheel (8) will be rotated in one direction to produce a reaction force. Therefore a shaft (5) and bearings (6) and framing supports (7) are required for the assembly wheel (8). Bearings (6) and supports (7) are on each side of the assembly wheel (8). Also for the drive or rotation, a gear motor (9) is required with a set of driver pulleys (10 and 11) and a belt (12), one larger pulley mounted (10) on the assembly wheel shaft (5) and one smaller pulley (11) mounted on the drive gear motor unit (9). This drive motor unit (9) could be a standard full speed motor without gear reduction. The drive motor (9) effective RPM speed of the shaft output could be controlled by various methods for either the normal speed motor or the slower gear motor.

FIG. 1C shows the motor (1) with a clamp (166) and bolt (167). The framing component can include the additional parts (7 and 177) that are shown in FIG. 1.

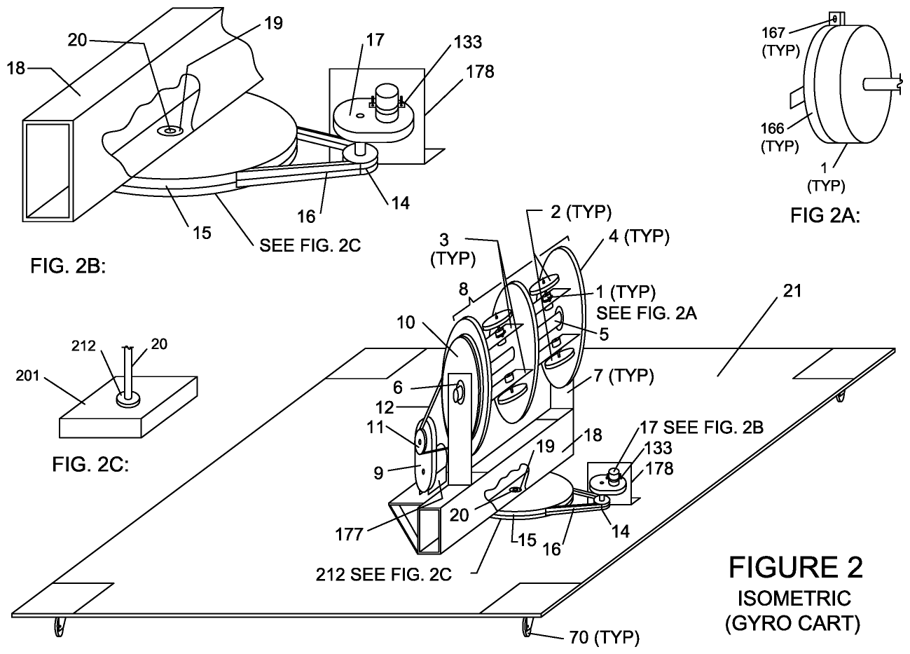

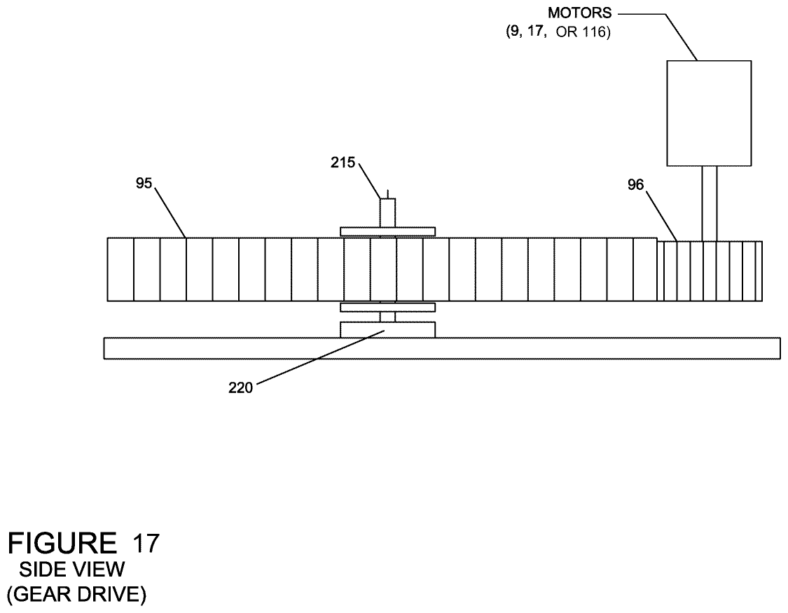

The position of the assembly wheel (8) as shown in FIG. 1 is such as to yield a parallel force with the road, with no pushing into the pavement. A first gyro motor (1) and flywheel (2) turn counter-clockwise, and the a second motor and flywheel turn clockwise, which will allow the assembly wheel (8) to create a reaction force, when it is rotated by a drive gear motor (9). The drive gear motor unit (9) can be a forward and reverse motor. An alternate construction includes large and small gears in lieu of pulleys for both drive system pulleys and for the turning system pulleys. (See FIG. 17 and FIG. 2.) A force is created by the rotation of the assembly wheel (8) when the gyro flywheels (2) are energized. Cart wheels or tires (13) are mounted on the craft framing for straight motion. Stacking the disk assembly wheel components (in rows) (57) will be additive for each component (57) to the total reaction force. A linear increase in the reaction force for each component (57) is the result. The stacking components (57) include the disk (4) with the gyro motors (1) and flywheels (2) as a single pair mounted inside.

Referring to FIG. 1A, the flywheel (2) will typically be made of light weight material for the disk, and have heavier metal weights (31) attached at the outer edges. Many construction techniques are possible such a wood or aluminum disk with heavy metal weights attached (31). FIG. 1D (PARTIAL) shows the attachment hardware for the weights (31), which can include bolts or rivets (38). All shafts are labeled with number 5 for common part function and notation. However, the shafts (5) in various embodiments all have different diameters and lengths according to the individual specifications.

FIG. 1B shows a single typical gyro assembly (57). FIG. 1C shows a typical motor (1) with a clamp (166) and bolt (167).

In FIG. 2, a steering electric gear motor (17) can be used to turn the complete assembly for steering the reaction force in other directions and likewise movement. The steering gear motor (17) would rotate the assembly wheel in angular position for movement in different directions. The wheels (70) for the craft would be swivel type, such as casters, to accommodate any directional force. The steering gear motor (17) should be a forward and reverse motor. Large pulley (15) and smaller pulley (14) for the gear motor (17) with a belt drive (16). The shaft (20), connecting hub (19) and bearing (212) for the steering drive allow the whole assembly to turn. Only a 180-degree rotation is required, since the gyro assembly drive gear motor (9) will be reversible. Swivel type wheels (70) are utilized for complete maneuverability to be used for man- lifts, etc. FIG. 2A shows the motor (1) with a clamp (166) and bolt (167). FIG. 2B is a detail view of the steering pulley (15) and the steering gear motor (17), mounted securely to a framing component (178) with a mounting clamp (133). FIG. 2C shows a lift block (201) for the bottom support bearing (212) and shaft (20). This maintains a clearance for the bottom pulley (15) and the cart (21). An alternate construction includes large and small gears in lieu of pulleys for both drive system pulleys and for the turning system pulleys. (See FIG. 17.) This could replace the required gear motors with standard motors and separate gears for the needed turn down. The gear motors (9 or 17) can be a standard full speed motors without gear reduction. The motors (9 or 17) effective RPM speed of the shaft output can be controlled by various methods for either the normal speed motor or the slower gear motor. The framing components can include the additional parts (7, 18, 177 and 178) that are shown. As mentioned previously, part numbers (1, 2, 3, 4, 5, 6, 8, 10, 11, and 12) are shown and identified.

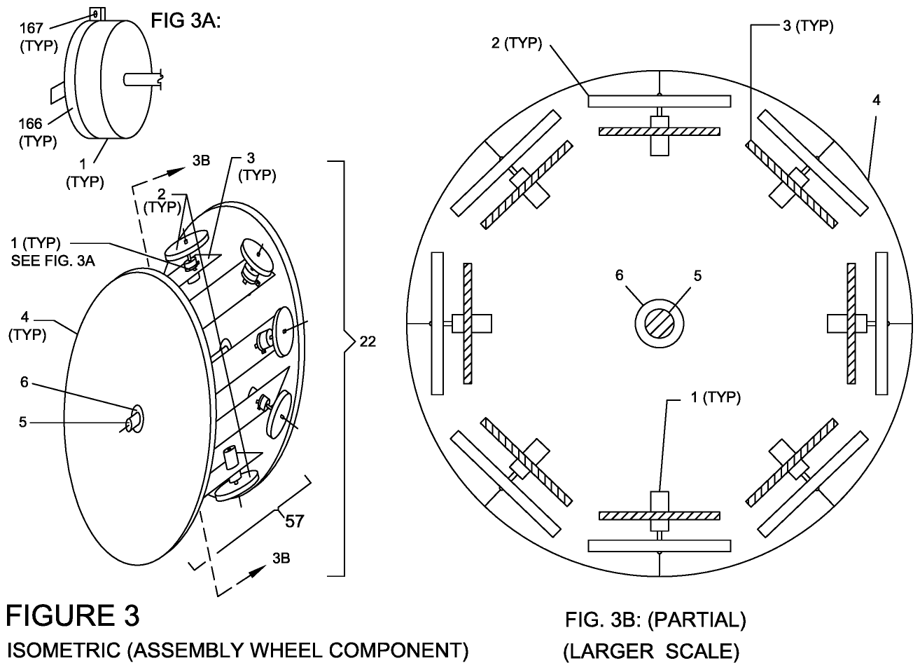

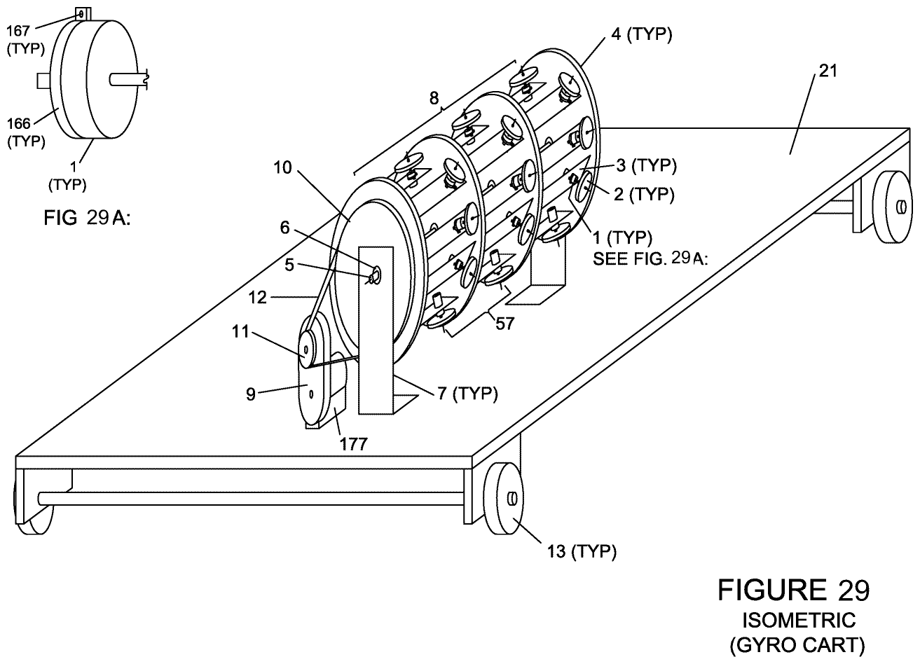

In FIGS. 3 and 3B, an alternate for the multi-row type gyro assemblies is a gyro assembly (22) with multi-pairs arranged in pairs (with 180-degree positioning of the flywheels) as a single component (57). However, multiple components (57) can again be stacked in a row for additional options, see FIG. 29. The angular positioning and rotation order is important and is described elsewhere. FIG. 3A shows a typical motor (1) with a clamp (166) and bolt (167). As mentioned previously part numbers (1, 2, 3, 4, 5, 6 and 57) are shown and identified. The component (57) is stackable, as previously described for other units. The cart and framing are not shown for clarity. (Refer to other figures for the cart drawings.)

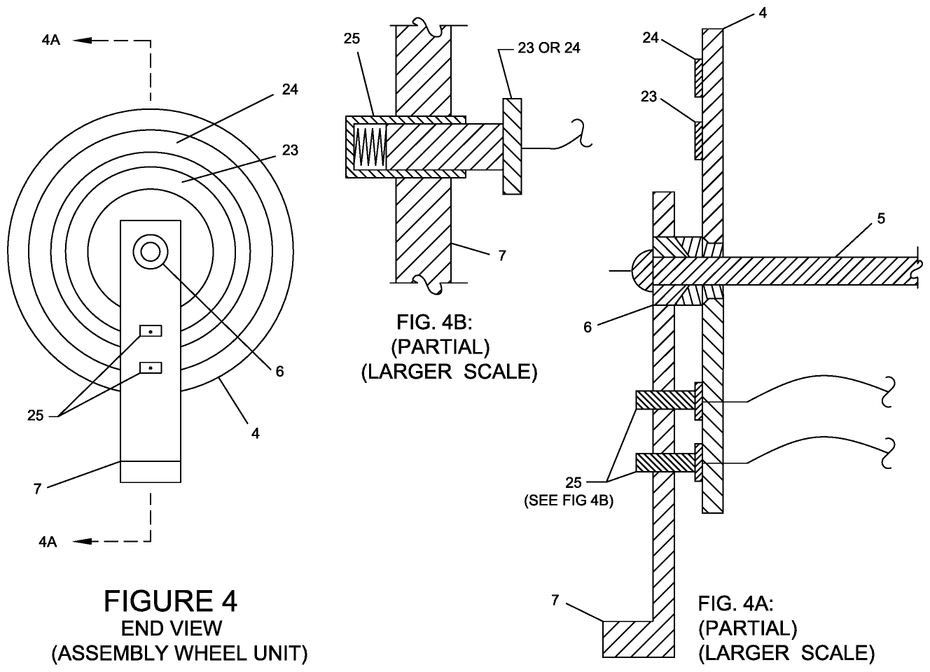

In FIG. 4, bronze washer like rings (23 and 24) are configured for electrical current delivery utilizing typical motor type brushes (25) with internal springs. One outer ring (24) and one inner ring (23) is mounted on one disk. Two different sized rings are used. Alternately one ring (23) of the same size ring can be mounted on the disk, one on each side. The feeder wires are shown leading away from the rings, but are not identified. As mentioned previously, part numbers (4, 5, 6 and 7) are shown and identified. FIG. 4B is a cutaway close-up side view showing a single brush with internal spring, mounted on a framing support (7). FIG. 4A is a cutaway side view of the disk (4) shown in FIG. 4, showing the interaction of the brushes (25) with the bronze rings (23 and 24), allowing current to flow.

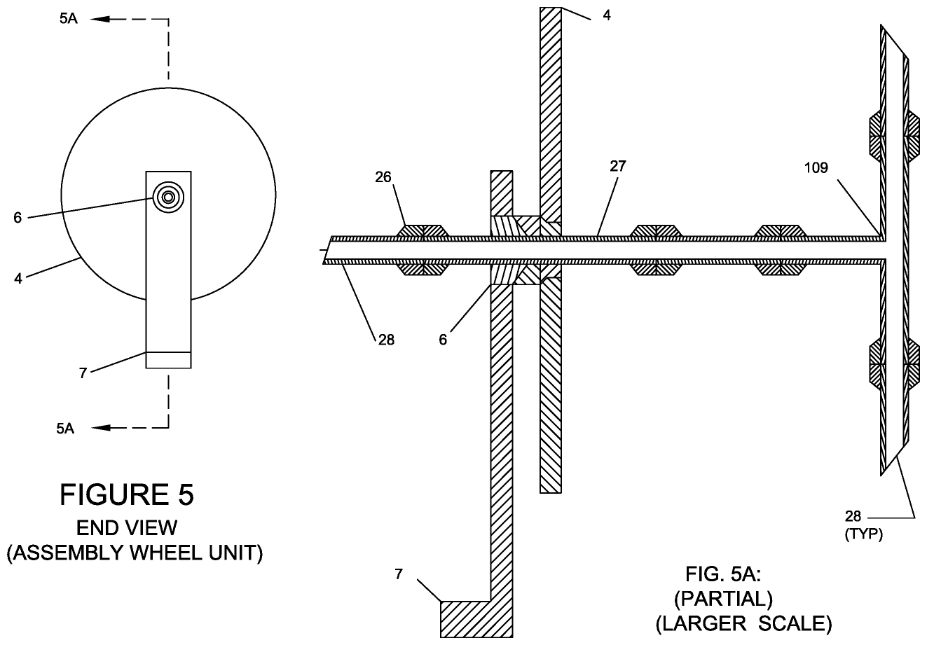

In FIGS. 5 and 5A, a hollow shaft (27) and swivel joint (26) permit delivery of fuel to the inside of assembly wheel for routing. On the outside of the assembly wheel unit a swivel joint (26) makes connection to a fuel line (28). On the inside, a fuel line (28) routes fuel to both engines. A tee (109) connection is required. One engine (29, not shown) turns counter clockwise and the other engine (29, not shown) clockwise. This design allows the assembly wheel (8, not shown) to remain symmetrical. As mentioned previously, part numbers (4, 6, and 7) are shown and identified. The part numbers (8 and 29) mentioned above are not shown in FIG. 5, but are present and shown in other figures.

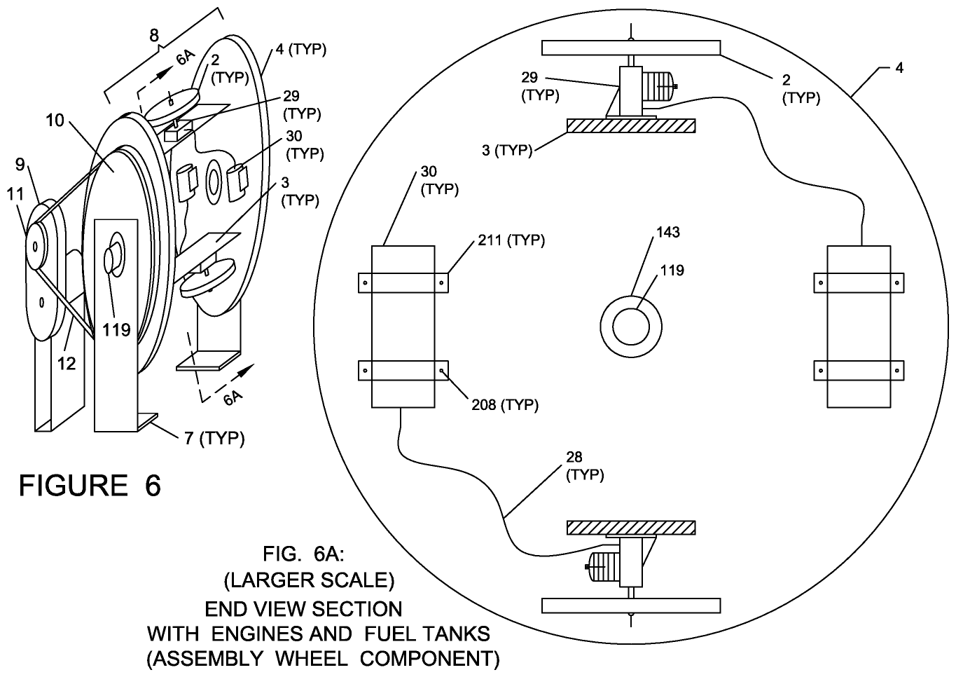

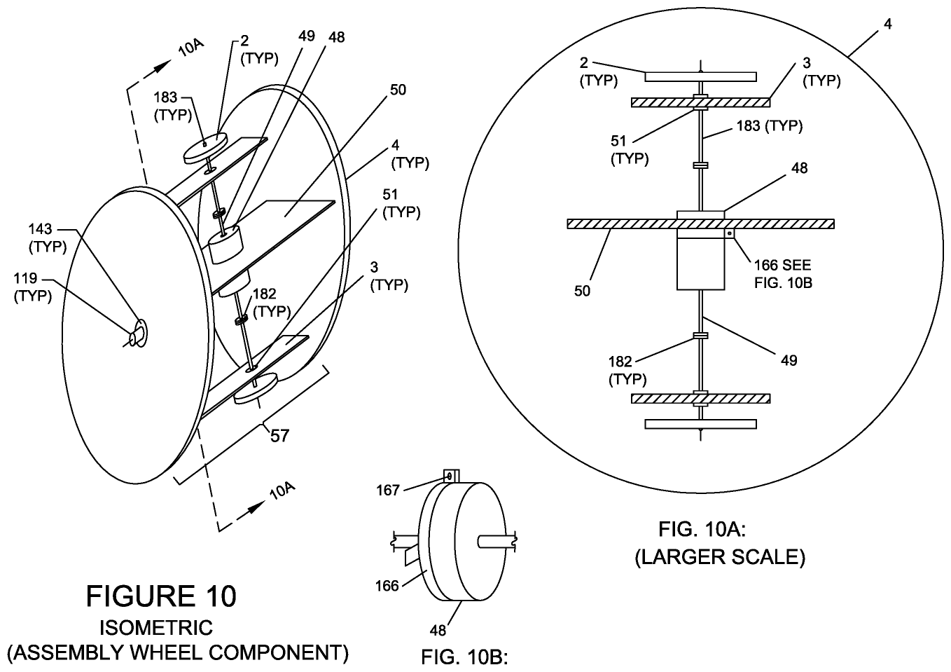

In FIG. 6, engine (29) driven flywheels (2) can be used as an alternate. On-board fuel tanks (30) can be used, mounted inside the assembly wheel (8). Each fuel line (28) connects each tank (30) to its respective engine (29). The position can be 90 and 270 degrees staggered away from the gyro flywheels (2) to partially help with the dynamic balancing, and provide a more even distribution of weight around the disk. The fuel tank is attached to the disk (4) by a mounting clamp (211) and bolts, rivets or screws (208). However, a fuel delivery system can be utilized by using a swivel joint (26) on the disk to allow the fuel to be delivered to the engine. (See FIG. 5 for the swivel joint (26).) This is an alternate flywheel drive system to that shown in FIG. 1. As mentioned previously, part numbers (3 and 5) are shown and identified. Part numbers 119 and 143 are described below with FIG. 10.

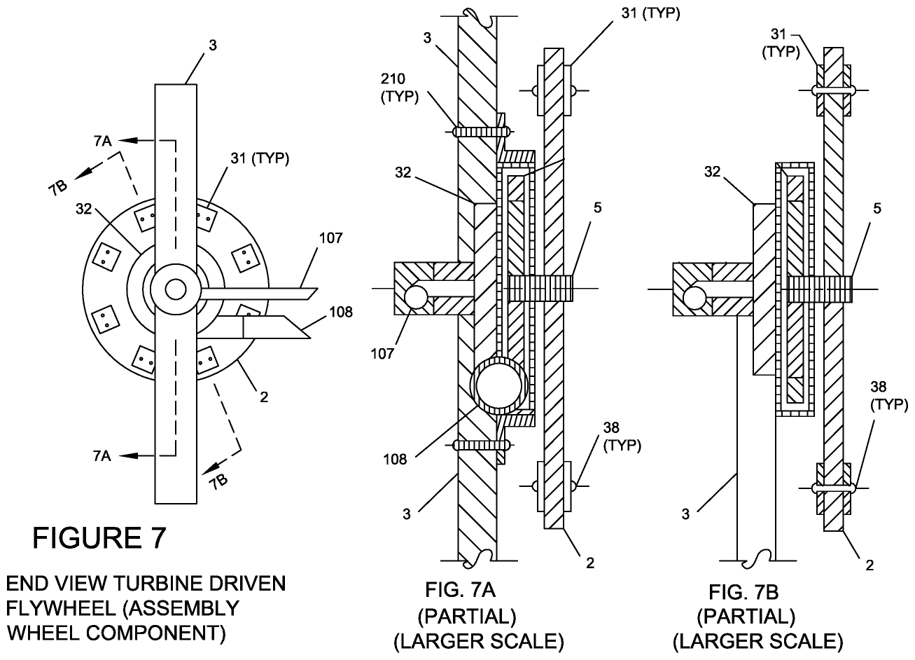

In FIG. 7, a turbine drive system is an alternate drive for the flywheels (2). The turbine (32) is mounted on the cross brace (3). An air pressure driven turbine (32) has two pipes, the inlet (107) and the outlet (108). The outlet (108) is not piped, but will be a free discharge for the air pressure turbine unit. The inlet (107) is connected to the air pressure piping. A swivel joint (26) is used for the supply air pressure with a pipe connection to a hollow shaft (27). (See FIG. 5 for the swivel joint (26) and hollow shaft (27).) A vacuum turbine (32) system is another alternative, but the piping connects to the low-pressure side, which is labeled (108) (mentioned previously as the outlet (108)). Both the pressurized air and vacuum turbine systems look essentially the same when drawn. A steam turbine can also be utilized. The drawing does not change, but the inlet (107) and outlet (108) connection are piped. The steam supply (107) and the return for the condensate (108) are piped. For steam, two swivel joints (26) are required, one on each side of the assembly wheel (8). (See FIG. 5.) Attachment hardware can include bolts or rivets (38) for the flywheel weights (31). The turbine is attached to the cross brace (3) by bolts, rivets, or screws (210), as shown in FIGS. 7A and 7B. As mentioned previously, part number (5) is shown and identified.

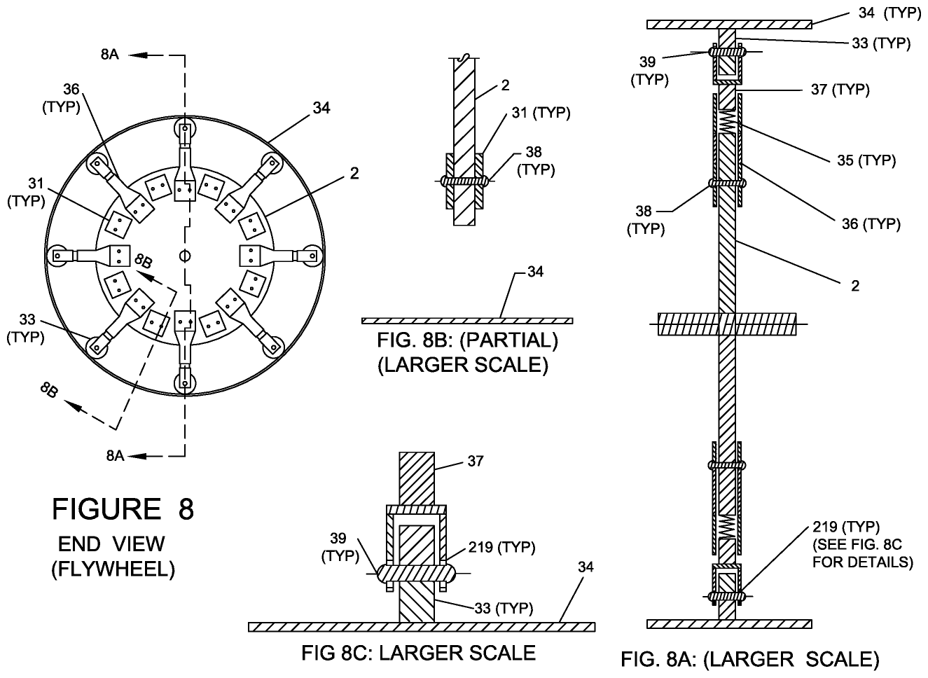

In FIG. 8, a sleeve (34), mounting bracket and tube (36), rollers (33) and pin (39) with piston or in FIG. 8A, a shaft with piston rods (37) for flywheels with springs (35) are used for preventing excess wobble of the flywheel (2). The wobble can be due to the gyro assembly wheel (8) speed changes. Each roller has two bearing members (219) comprising of bearings, one on each side, shown in FIG. 8C. Attachment hardware can include bolts or rivets (38), shown in FIG. 8B. As mentioned previously, part number (31) is shown and identified. The part number (8) mentioned above is not shown in FIG. 8, but is shown in other figures. FIGS. 8A, 8B and 8C are included to show the details.

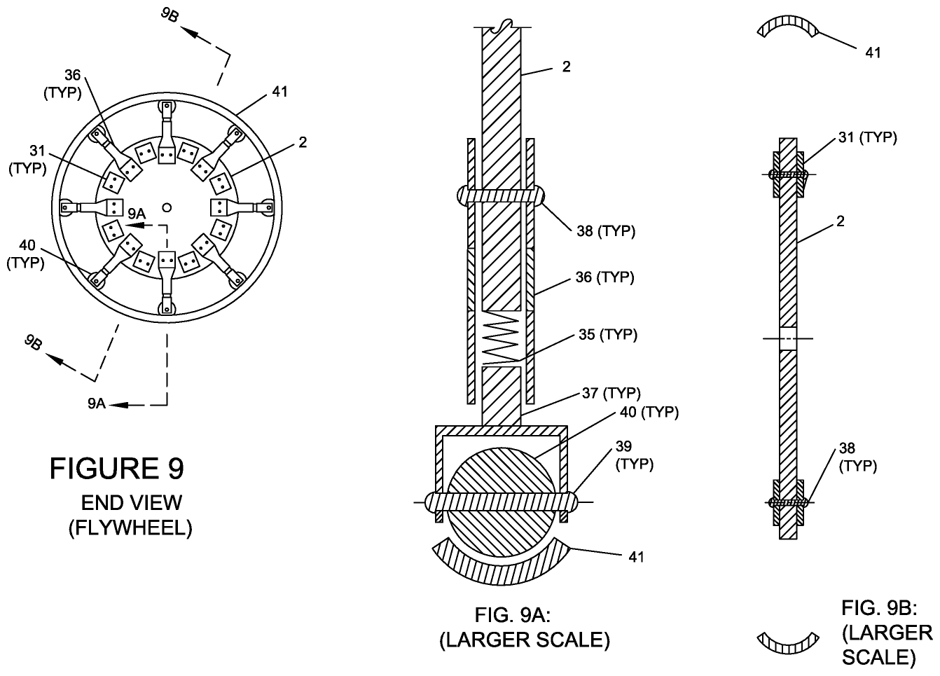

In FIG. 9, a spherical roller (40) with pin (39) can be used with a trough (41) to ride. A mounting bracket and tube (36) with a piston rod (37) and a compression spring (35) are used to steady the flywheel smoothly (see FIG. 9A). Attachment hardware can include bolts or rivets (38). The view shown in FIG. 9B is analogous to that shown in FIGS. 1D and 8B. As mentioned previously, part numbers (2 and 31) are shown and identified. FIGS. 9A and 9B are included to show the details.

In FIG. 10, an alternate for the two gyro electric motors (1) is a double ended gyro electric motor (48) for the pair of flywheels (2). The motor can be positioned in the center of the assembly wheel component (57) for dynamically balancing the assembly wheel (8). The motor is supported on a cross brace (50). The set of shafts (49 and 183) drives both flywheels (2), making a pair. The two cross brace supports (3) hold the two bearings (51) in position, which are close to the flywheels (2). The bearings (51) can be mounted on the inside from the flywheels (2) as shown in FIGS. 10 and 10A, or on the outside. The external shafts (183) are connected by couplings (182) to the motor's shaft. If an extra-long shaft from the motor (1 or 48) is used, these two parts would not be necessary. For the component (57), the shorter shafts (119) can connect to each disk by a flange or shoulder hub connection (143) to the disk (4). One shaft (119) and flange hub (143) are required on each end of the assembly wheel (8). The hub (143) connects to the disk (4) perpendicular on both sides and makes the unit ready for the brackets that support the assembly wheel. The component (57) is stackable, as previously described, etc. for other units. FIG. 10B shows the motor (48) with a clamp (166) and bolt (167). The cart and framing are not shown for clarity. (Refer to other figures for the cart drawings.) The part number (8) mentioned above is not shown in FIG. 10, but is shown in other figures.

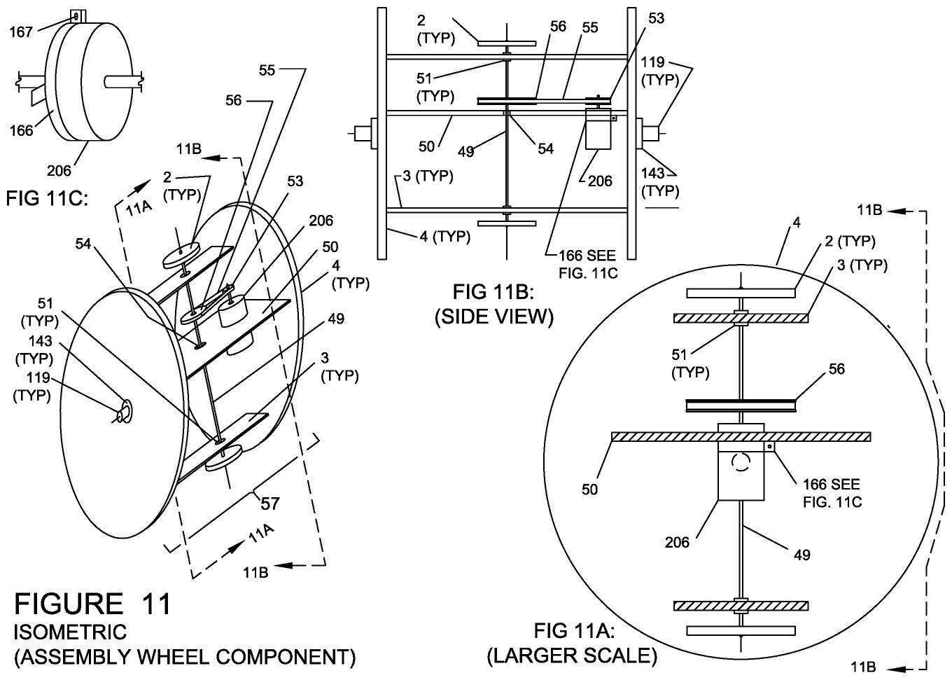

FIG. 11 shows an alternate design of a flywheel pair (2) with a long shaft (49), supported by a cross brace (3) and bearings (51), large pulley (56) and a single motor (206) with small pulley (53). The electric motor (206) is supported on a cross brace (50) with a hole (54) for the flywheel long shaft (49) (See FIGS. 11 and 11B). A belt (55) connects the two pulleys; motor pulley (53) and shaft pulley (56). The shaft (49) goes through a hole (54) in the cross brace (50). The shorter shafts (119) will connect to each disk by a flange or shoulder hub connection (143) to the disk (4). The hub (143) connects to the disk (4) perpendicular on both sides and makes the unit ready for the brackets that support the assembly wheel. FIG. 11C shows the motor (1) with a clamp (166) and bolt (167). FIG. 11A provides another view of the interior of the assembly component (57). The component (57) is stackable, as previously described, etc. for other units. The cart and framing are not shown for clarity. (Refer to other figures for the cart drawings.)

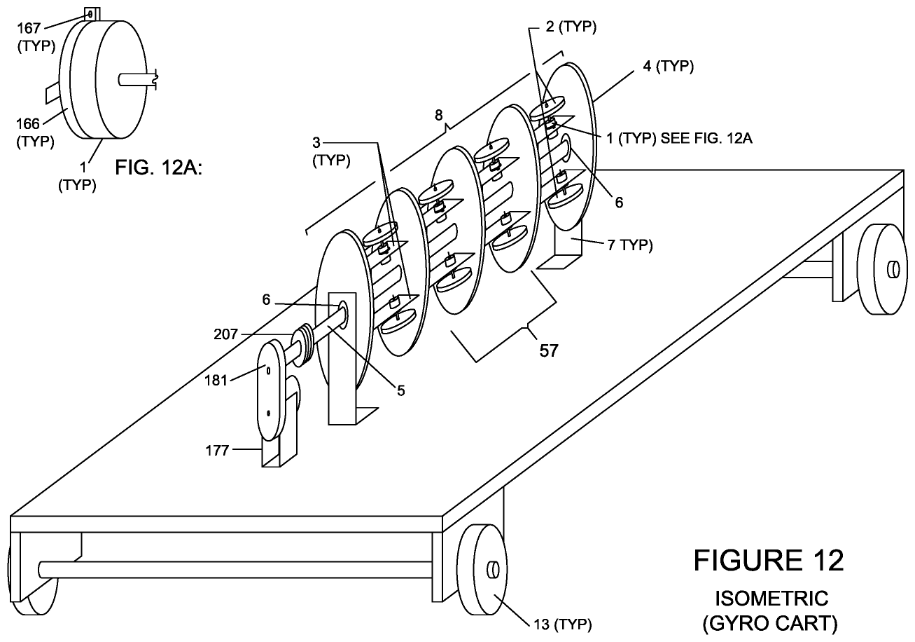

FIG. 12 illustrates a magnetic coupling (207) that can be used for speed control as an alternate mechanism. Also the drive electric gear motor (181) can be reversed in rotation for a reverse directional reaction force. This gear motor (181) has a different gear ratio than the previous gear motor (9) shown in FIGS. 1, 2 and 6, since it is directly coupled. This gear motor (181) has a higher gear ratio for more gear down. FIG. 12A shows the motor (1) with a clamp (166) and bolt (167). The framing components can include parts (7 and 177) that are shown and identified. As mentioned previously, part numbers (1, 2, 3, 4, 5, 6, 8 and 13) are shown and identified.

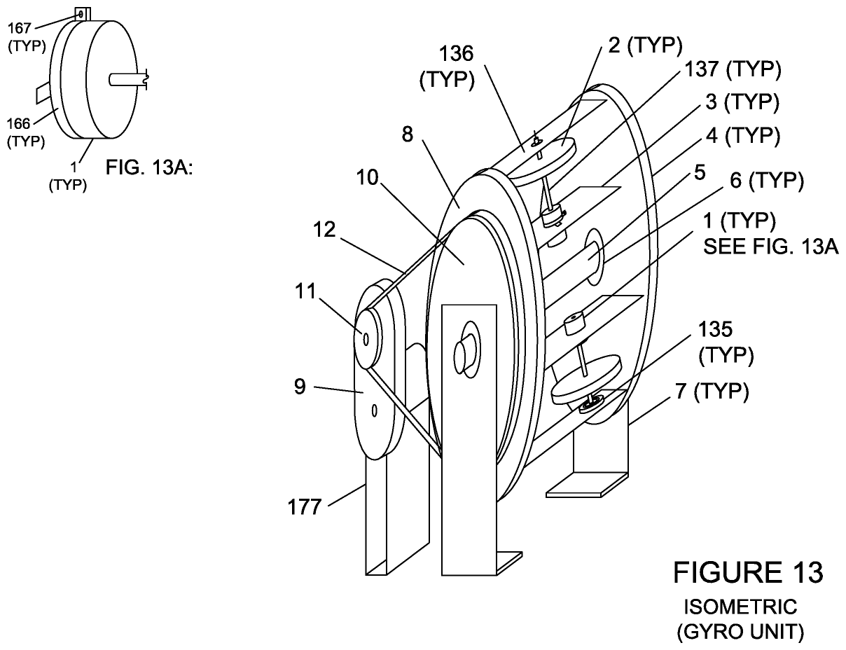

FIG. 13 shows two external additional magnetic bearings (135) for each gyro motor shaft (137). This shaft (137) is connected to and drives the two flywheels (2) normally, but on previous figures without external magnetic bearings (135). The two cross brace supports (136) hold the two additional magnetic external bearings (135) in position, etc. The shafts (137) for the motor are long and run into the external magnetic bearing (135). FIG. 13A shows the motor (1) with a clamp (166) and bolt (167). The cart is not shown for clarity. (Refer to other figures for the cart drawings.) The framing components can include the additional parts (7 and 177) that are shown. As mentioned previously, part numbers (1, 2, 3, 4, 5, 6, 7, 8, 9, 10, 11, 12) are shown and identified.

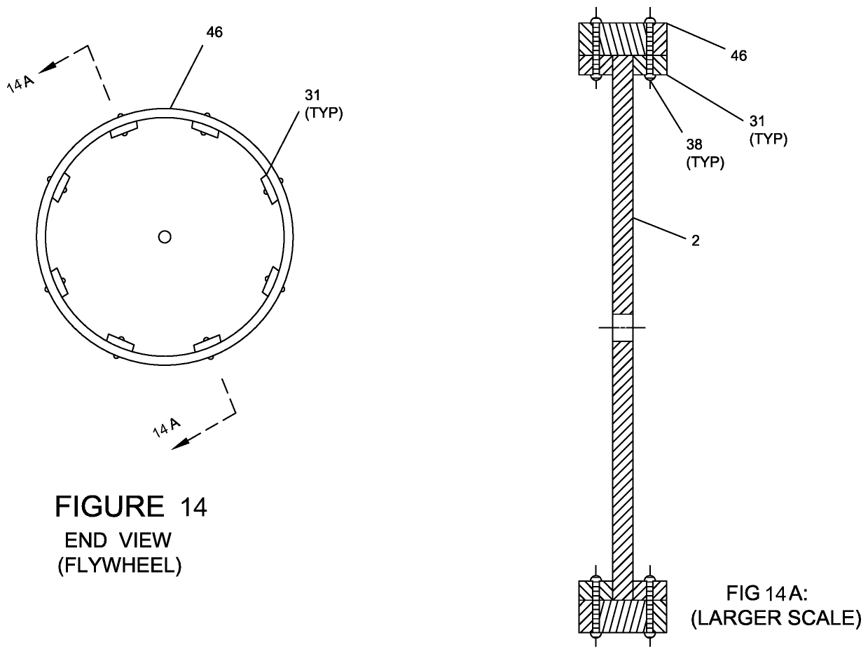

FIG. 14 shows an alternative to a disk flywheel (2), which is a rim flywheel (46) with weights (31) about the inner perimeter. The weights are attached and can be held in place by rivets or bolts (38) (See FIG. 14A).

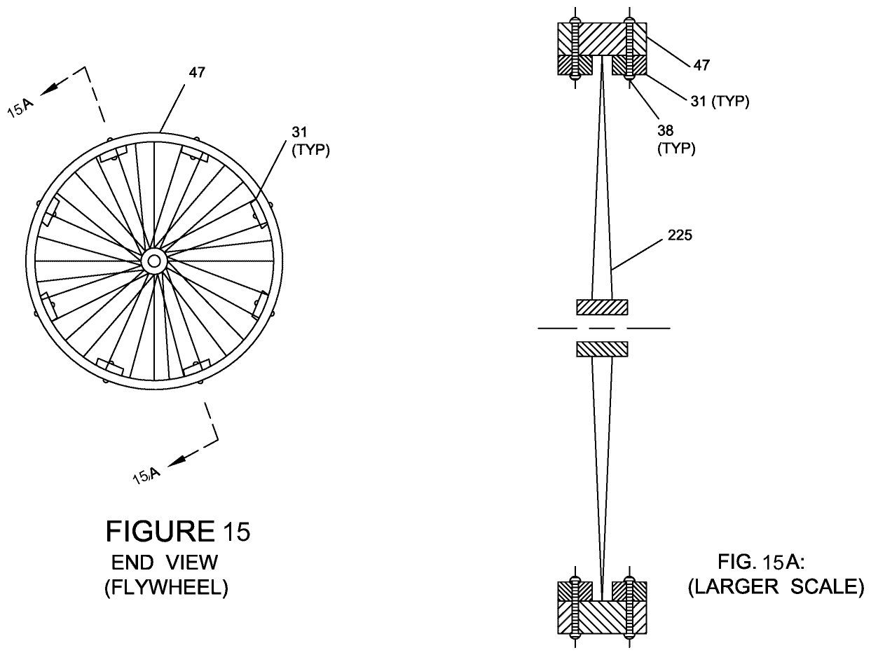

FIGS. 15 and 15A shows an alternative construction for the gyro flywheel, which utilizes normal spoke (225) rim wheels (47) for the flywheels, with normal connection to the motor shaft (5). Flywheel weights (31) are attached to the rim. Attachment hardware can include bolts or rivets (38).

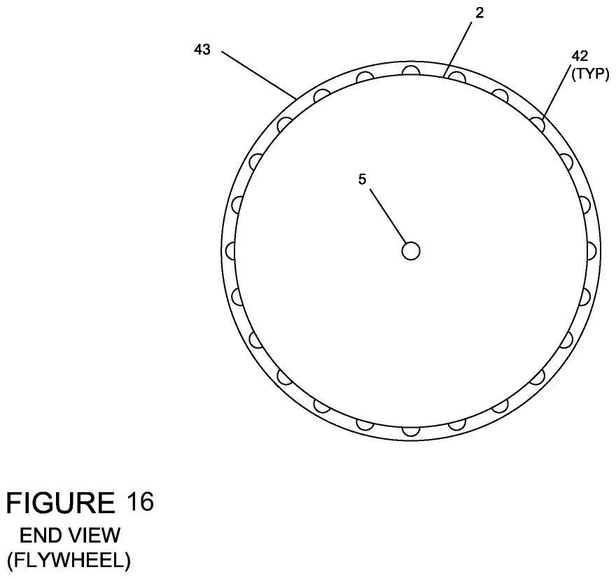

FIG. 16 shows an embodiment similar to that shown in FIG. 8, to prevent the flywheels (2) from wobbling and for smaller applications, utilizing skid knobs (42) with a sleeve (43). As mentioned previously, part number (5) is shown and identified.

Shown in FIG. 17, an alternative for the pulley arrangement is a gear to gear arrangement for turning the gyro unit for changing directional movement or for the assembly wheel drive system (See FIGS. 1 and 2) Typically one larger gear (95) and shaft (215) with one smaller gear (96) for the motors or gear motors (9, 17, or 116) are used. The larger gear utilizes bearings (220).

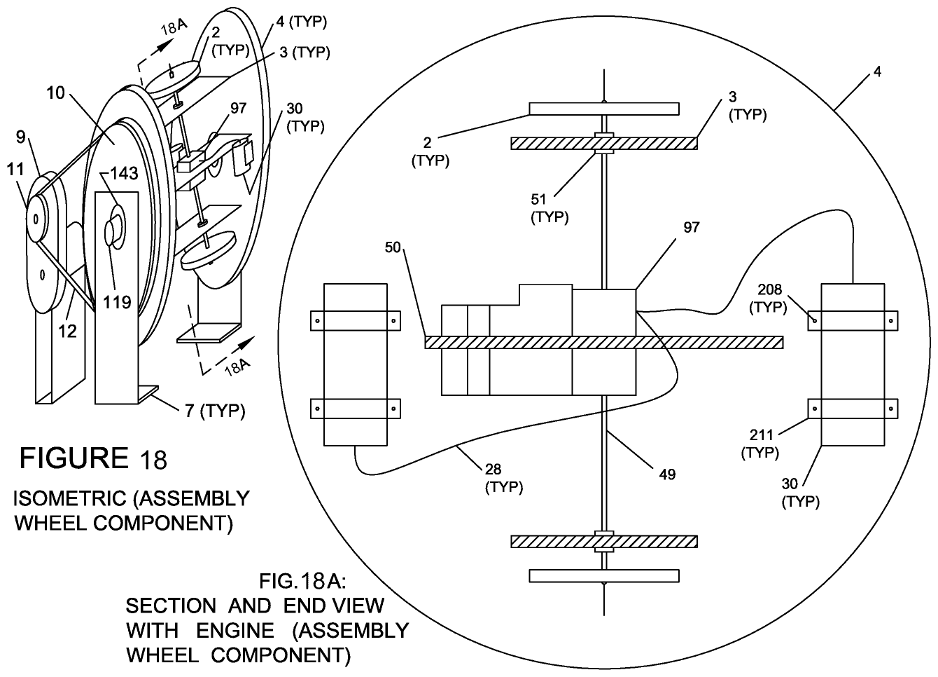

In FIG. 18, another alternative is a double ended engine driver (97) with a flywheel pair (2) and with a single long shaft (49) and bearings (51). The cross piece or framing support (50) that connects across to each disk (4) is shown. This holds the engine in position, as also shown in FIG. 18A. This is an alternate for FIG. 10A and FIG. 10, and adds aspects of FIG. 6. As mentioned previously, part numbers (3, 7, 9, 10, 11, 12, 28, 30, 119, 143, 208, and 211) are shown and identified.

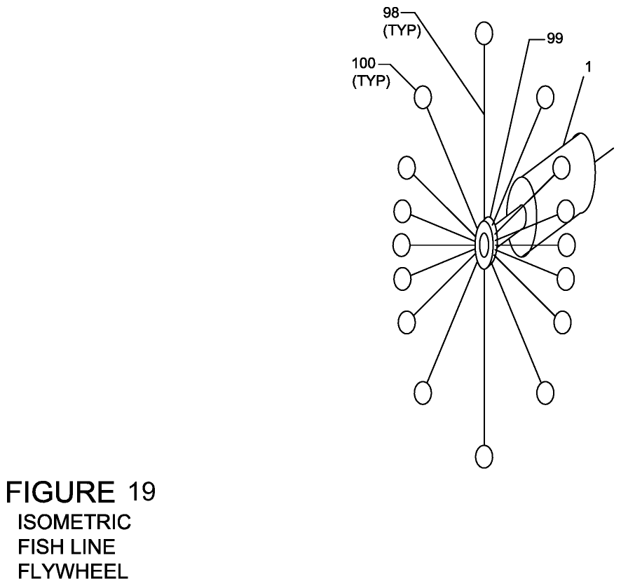

FIG. 19 illustrates an arrangement for smaller units wherein a flywheel that is composed of multiple fish line components (98) extending from a hub (99), and spherical weights (100) attached to the fish line on the distal end from the hub. In combination with a flywheel motor (1), this embodiment can serve for the flywheel and motor.

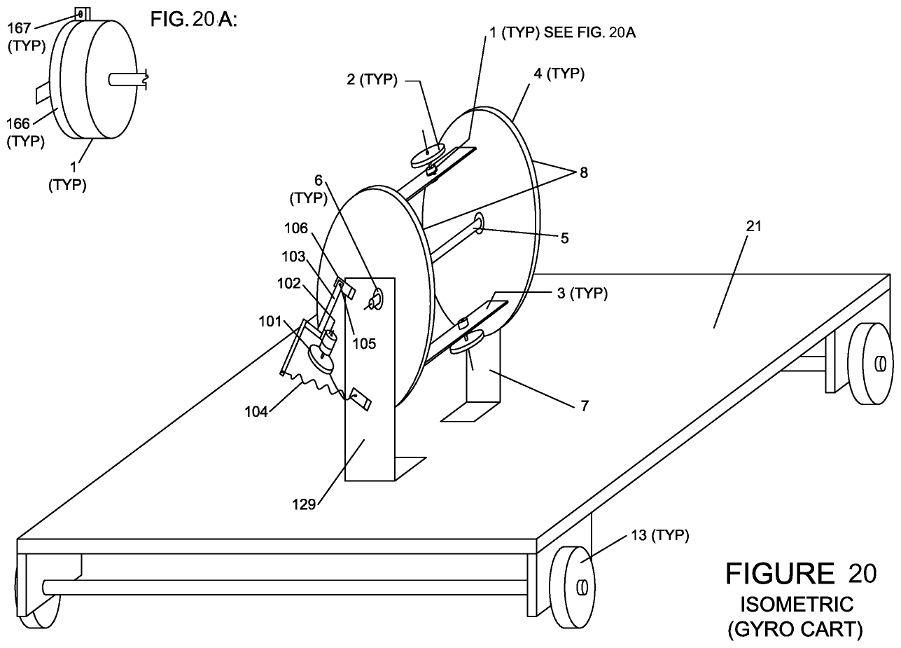

FIG. 20 illustrates another arrangement for small applications wherein a combination of rubber wheel drives (101) can be used. A motor (102) drives each rubber drive wheel. A lever (103) with spring (104) keeps the pressure on the disk assembly wheel (8). The lever has a pin connection (105) at the bracket (106). Two rubber wheels (101) can be used; one on each disk wheel or one on each side will effectively make the pressure force offset each other. Therefore, the effective force on the assembly wheel bearings (6) will be zero. Different positions on the lever (103) for the rubber wheel (101) are possible for different gear ratios, as the rubber wheel spot radius on the assembly wheel disk (4) is changed. Refer back to FIG. 1 for typical electric motor driven flywheels unit. The unit support (129) is wider than the normal support ((7) and see, e.g., FIGS. 1, 2, 4, 5, 6 item (7)) since it holds the bracket (106) and the unit bearing (6). FIG. 20A shows the motor (1) with a clamp (166) and bolt (167). As mentioned previously, part numbers (2, 3, 5, 13, and 21) are shown and identified.

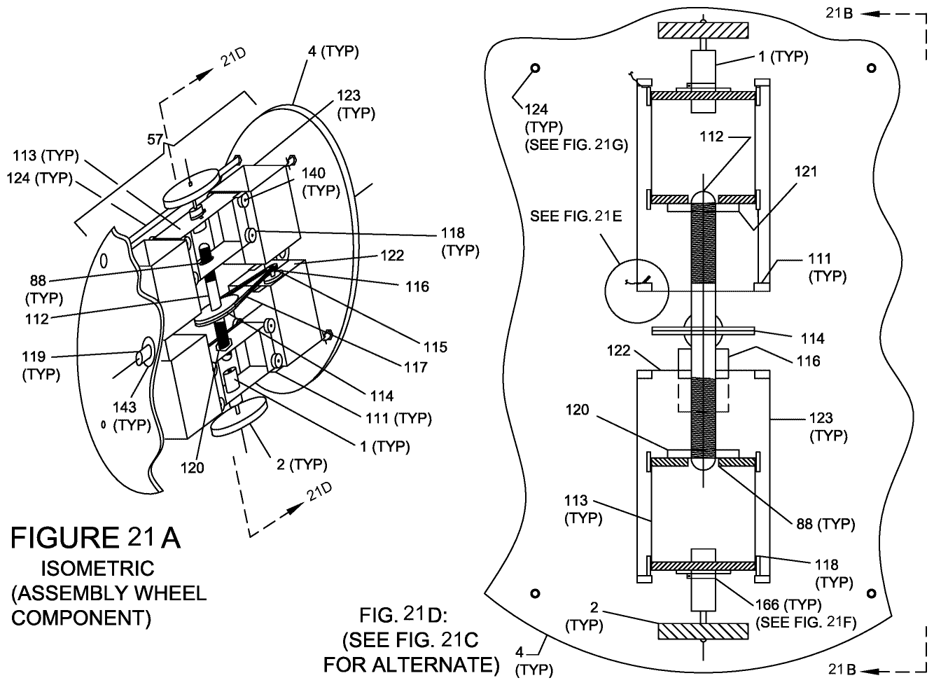

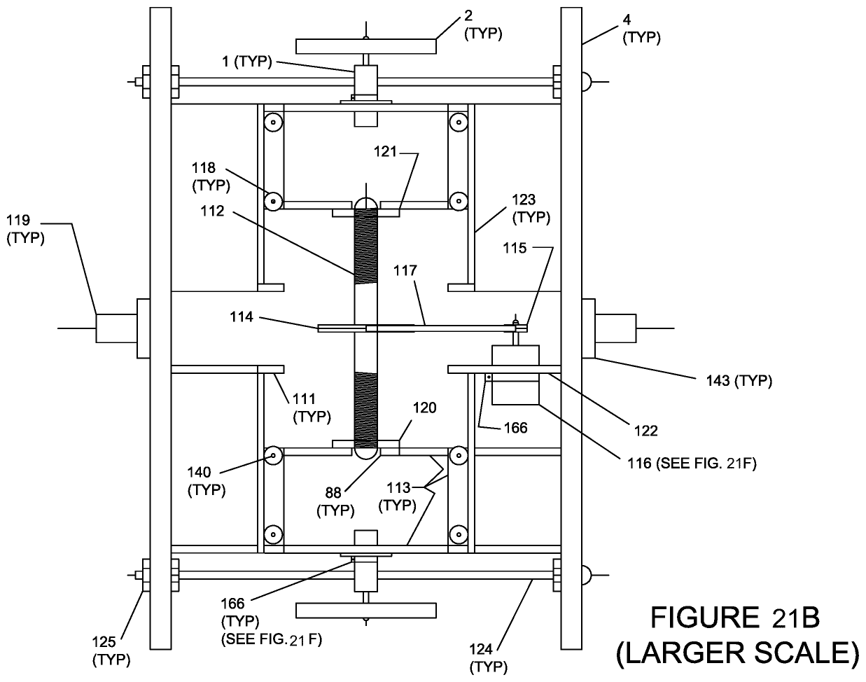

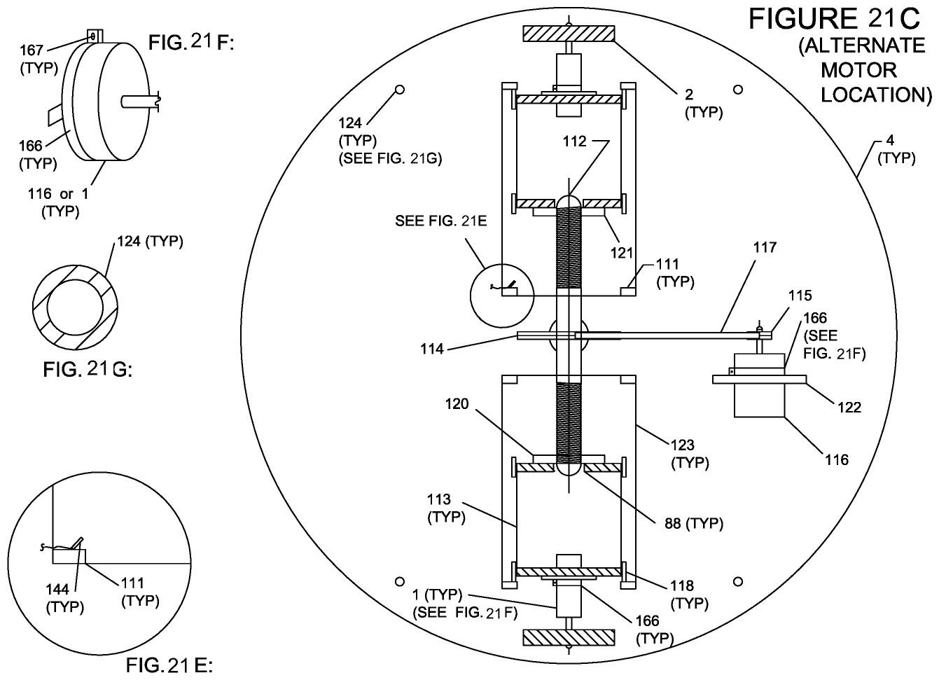

In FIGS. 21A, 21B, 21C and 21D, the cart is not shown for clarity. (Refer to other figures for the cart drawings.) For this design, moving the gyro electric motor (1) and flywheel (2) in and out of the two disk gyro assembly wheel component (57) changes the radius, and likewise the reaction force, at a set speed of the unit and of the flywheels (2). Both flywheels (2) should be moved identically or symmetrically to maintain a diametric arrangement of the gyro assembly wheel component (57). A screw gear type shaft (112) with a left-handed screw gear thread on one side and a right handed screw gear thread on the opposite side pushes the gyro flywheels (2) apart or pulls them together, when the screw gear shaft rotates clockwise or counter clockwise. The screw gear shaft (112) is threaded to match each threaded plate (120 and 121); one plate is left handed (120) and the other opposite (121). The threaded plates (120 and 121) are shown as hexagons in FIG. 21A, similar to a regular nut. The threaded plates (120 and 121) are attached to each frame (113), which replaces the frame (3) which has been shown in the embodiments shown in FIGS. 1-3, 6, 7, 10-13, 18, 18 and 20. Each frame (113) has a hole (88) for the gear screw drive shaft (112) to pass through. Each frame (113) also holds a flywheel (2) and motor (1) and allows movement towards and away from the center of the assembly wheel component (57). Each frame (113) has wheels (118) with shafts (140) that roll on a platform frame (123) (See FIGS. 21A and 21B). The screw gear shaft (112) is turned by a pulley arrangement. One large pulley (114) on the screw gear shaft (112) and one smaller pulley (115) on the reversible motor (116) connected by a belt (117) (See FIGS. 21A, 21B and 21C). The motor (1) and flywheel (2) moved equally towards or away from the center of the assembly wheel component (57). This motor (116) is attached to a mounting cross brace (122). Stops (111) and limit switches (144) will prevent the motor from running too far in a direction (See FIGS. 21C, 21D and 21E). Controls and electrical power can be routed through the disk by utilizing bronze washer-type rings and brushes, similar to part numbers 23, 24 or 25 as previously noted in FIG. 4 above. Controls (62) can be mounted on the craft framing (not shown). Four connecting rods (124) with double nuts (125) connect the two disks and maintain a proper pressure for the rollers to ride smoothly with proper alignment (See FIGS. 21B and 21G). Some adjustment will be required. Wood or plastic cross bracing is an alternative for connecting rods (124). The shorter shafts (119) do not run through to connect both disks (4) (See FIGS. 21A and 21B). The shorter shafts (119) are secured to each disk with a flange or shoulder hub connection (143). The hub (143) connects to the disk (4) perpendicular on both sides and makes the unit ready for the brackets that support the assembly wheel. An alternate location for the gear screw-drive motor (116), etc. is shown in FIG. 21C. Only one limit switch (144) is required for each direction (in or out), since turning the screw drive motor off with the one switch (144) will cause the stopping position of each gyro flywheel in relation to the center of the assembly wheel component (57) to be identical. (See FIGS. 21D and 21E.) Controls can be used to restart the drive motor in the opposite direction for the next engagement after a limit switch has deactivated the drive motor. FIG. 21E shows a clamp (166) and bolt (167) to hold each motor (1 or 116) in position. The assembly wheel component (57) is stackable, as previously described, etc. for other units. The screw gear shaft motor (116) can be replaced with a gear reduction motor unit.

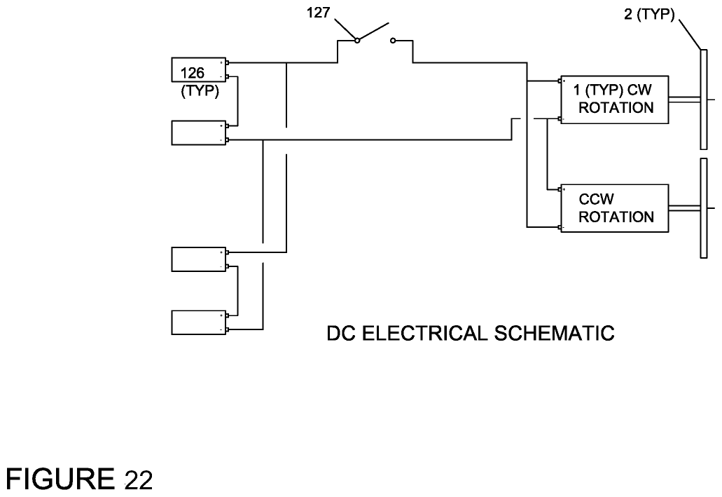

In FIG. 22, a wiring diagram for an 18 volt DC system for a toy model assembly wheel and cart unit is shown. Nine volt batteries (126) are wired in series with an on/off switch (127) using 18V DC motors (1) with their flywheels (2). Note that the motors rotate opposite. One motor rotates counter-clockwise, and the other clockwise.

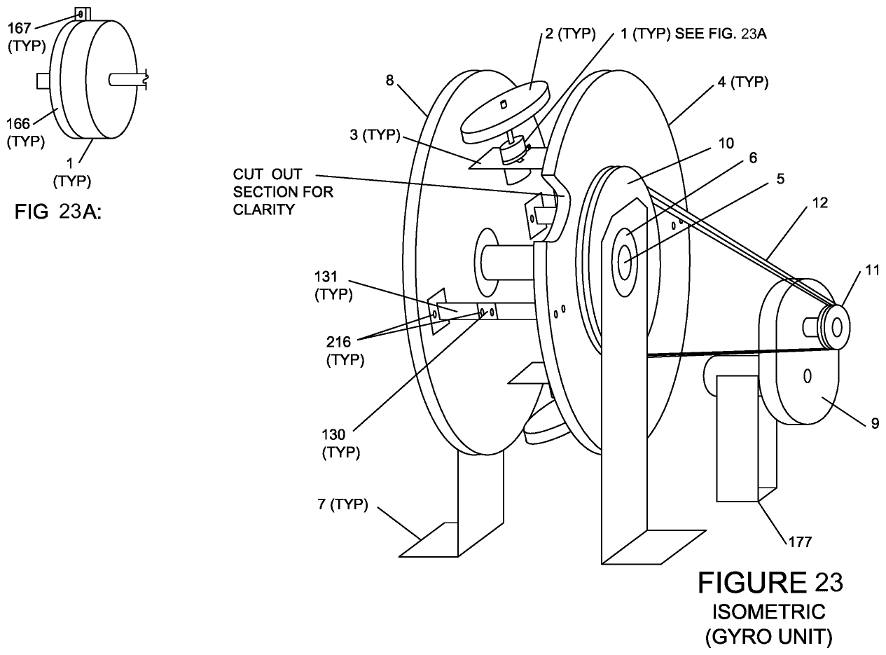

In FIG. 23, an alternate embodiment for single pair ground units (gyro assembly wheels) includes additional weights (130) mounted on the assembly wheel disk at 90 and 270 degrees. The weights (130) can be held in place by rivets or bolts (216). This represents a 90-degree rotational offset from the flywheel locations. A cross brace (131) can be attached by rivets or bolts (216) to position the weights. A cutout section of the disk allows the matching second cross piece (131) to be seen in FIG. 23. The cart is not shown for clarity. (Refer to other figures for the cart drawings.) Alternate arrangements can be imagined which would fall within the scope of the invention. FIG. 23A shows a motor (1) with a clamp (166) and bolt (167). The framing components can include the additional parts (7 and 177) that are shown and identified. As mentioned previously, part numbers (2, 3, 4, 5, 6, 8, 9, 10, 11 and 12) are shown and identified.

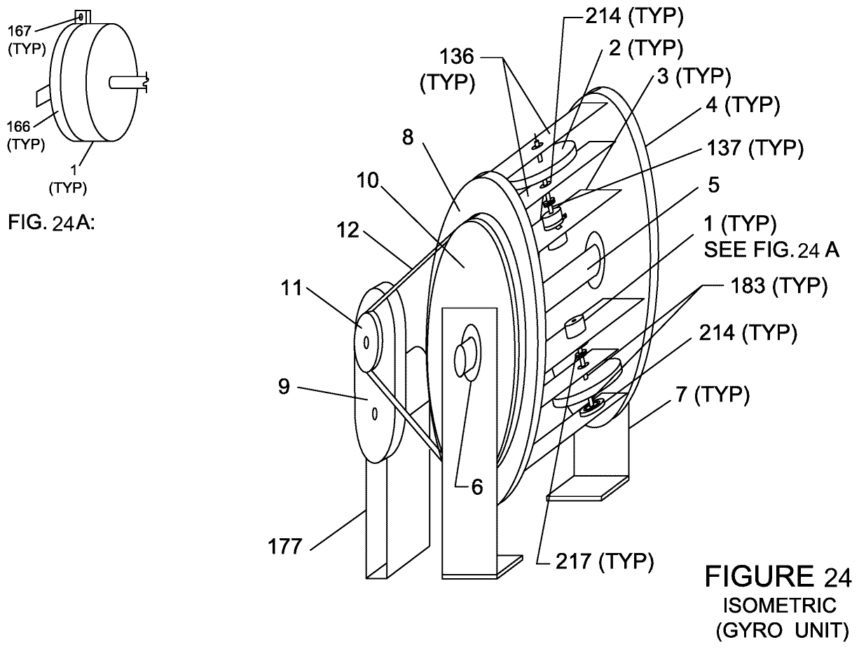

FIG. 24 shows the gyro wheel unit (8). It shows two additional bearings (214) for each gyro flywheel shaft (183). This shaft (183) is connected to and drives the two flywheels (2), but on previous figures without additional bearings (214). For each flywheel (2) and shaft (183), the two cross brace supports (136) hold the two additional bearings (214) in position, one inside and one outside. (Four total bearings (214) for each flywheel pair.) The external shafts (183) are connected by two couplings (217) to the motor's shaft (137). If an extra long shaft from the motor (1) is used, then these two parts (183 and 217) would not be necessary. FIG. 24A shows a motor (1) with a clamp (166) and bolt (167). The cart is not shown for clarity. (Refer to other figures for the cart drawings.) The framing components can include the additional parts (7 and 177) that are shown and identified. As mentioned previously, part numbers (3, 4, 5, 6, 9, 10, 11 and 12) are shown and identified.

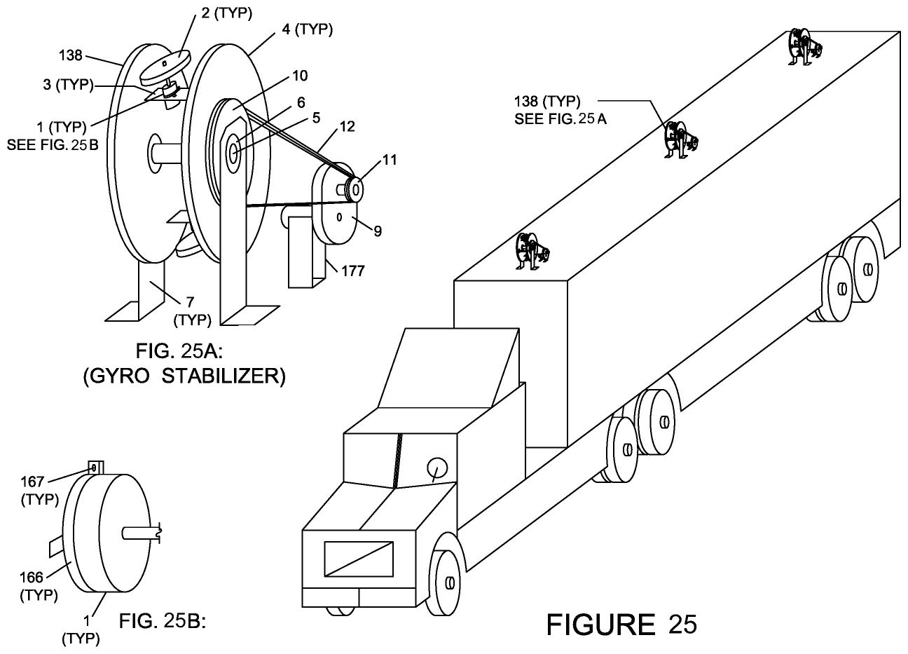

FIG. 25 shows three pusher/stabilizer type gyro force generating units (138) mounted on a tractor-trailer truck. These units (138) can use electric driven motors or other types, such as PTO hydraulic driven motors. The three units sit on the top of the trailer, to provide a force opposite the turning centrifugal force that naturally occurs during highway turns for the tall trailer. This provides a safer turning capacity for 18 wheel trucks during high speed travel. The gyro assembly drive motors are reversible to provide left or right turn assistance for the tall and loaded trailer. FIG. 25A is an enlarged isometric view of the gyro stabilizer unit. FIG. 25B shows the motor (1) with a clamp (166) and bolt (167) to hold the motor (1) in position. The framing components can include the additional parts (7 and 177) that are shown and identified. As mentioned previously, part numbers (2, 3, 4, 5, 6, 9, 10, 11 and 12) are shown and identified.

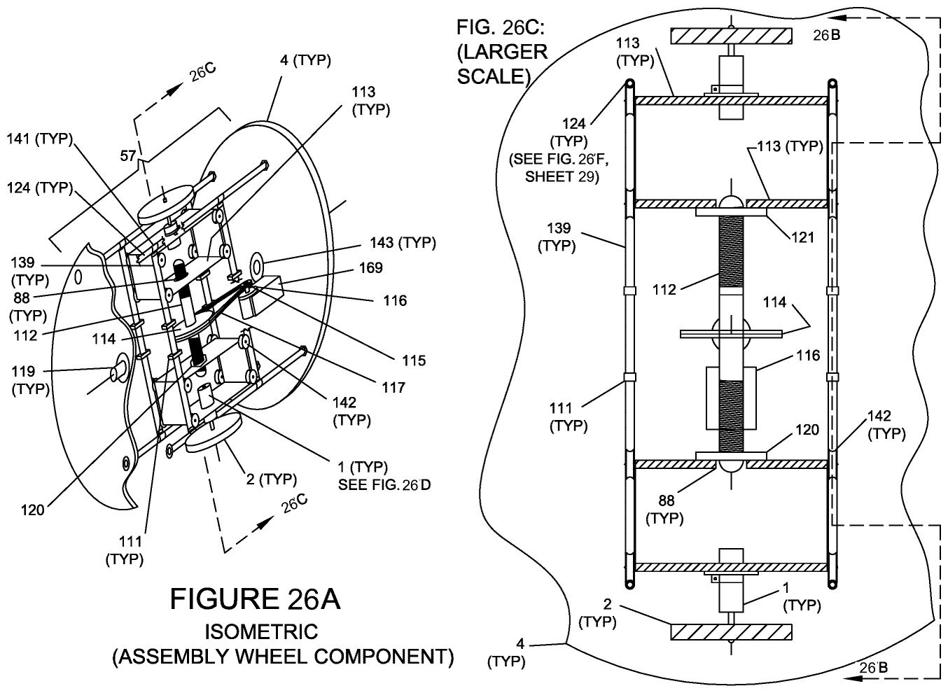

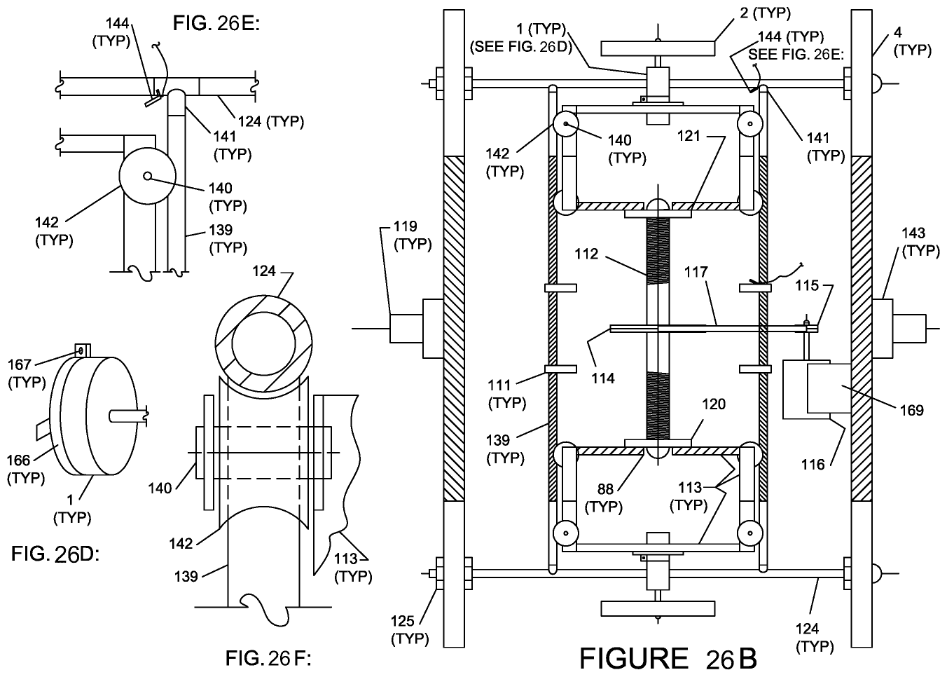

Referring to FIGS. 26A, 26B, and 26C, the cart is not shown for clarity. (Refer to other figures for the cart drawings.) The gyro electric motor (1) and flywheel (2) moves in or out of the two disk gyro assembly wheel, thus changing the radius and likewise the reaction force. The gyro flywheels (2) are set at a constant speed. The assembly wheel RPM speed can be adjusted as normal. However, this system allows more adjustment for the total magnitude of the reaction force in addition to the assembly wheel RPM speed. Both flywheels (2) move identically or symmetrically to maintain a diametric arrangement of the gyro assembly wheel. A screw gear type shaft (112) with a left-handed screw gear on one end and a right handed screw gear on the opposite end pushes the gyro flywheels (2) apart or pulls them together, when is the screw gear rotates clockwise or counter clockwise. The screw gear shaft (112) is threaded to match each threaded plate (120 and 121); one plate is left handed (120), and the other opposite (121). These plates are shown as hexagons, similar to a regular nut. The threaded plates (120 and 121) are attached to each frame (113). Each frame has a hole (88) for the gear screw drive shaft (112) to pass through. A shorter shaft (119) for the assembly wheel is used on each disk (4). The shorter shafts (119) connect to each disk by a hub or flange connection (143). The hub (143) connects to the disk (4) perpendicular on both sides and makes the unit ready for the brackets that support the assembly wheel. A frame (113) that houses or contains the flywheel (2) and motor (1) allows movement towards and away from the center of the assembly wheel component (57). It has wheels (142) with shafts (140) that roll on a rod (139). The roller rods (139) are cylindrical and can be metal tubing (such as aluminum, bronze or stainless steel). There are a total of four roller rods (139) for the unit. Alternatively, the roller rods (139) can be made of strong plastic or even wood. Each roller rod (139) can have two tee connections (141), one on each end of the rod (See FIG. 26E). The screw gear shaft (112) can be turned by a pulley arrangement. One large pulley (114) on the screw gear shaft (112) and one smaller pulley (115) on the reversible motor (116) are connected by a belt (117). The motor (1) and flywheel (2) move equally towards or away from the center of the assembly wheel component (57). This makes a perfect gyro flywheel pair. This motor (116) is attached to a motor mount frame (169). Stops (111) and limit switches (144) can prevent the motor from running too far in a direction (See FIGS. 26C and 26E). The motor (116) is protected from overloading. Controls and electrical power can be routed through the disk by utilizing bronze washer types rings and brushes, similar to (23, 24 & 25) as previously noted in FIG. 4 above. Controls (62) can be mounted on the craft framing (not shown). The four connecting rods (124) with double nuts (125) are configured to connect the two disks and maintain a proper spacing and pressure for the rollers (139) to ride smoothly with proper alignment (See FIG. 26F). These rods (124) can be metal tubing, aluminum, brass or stainless steel. Some adjustment will be required. Wood or plastic cross bracing is an alternative to the connecting rods (124). FIG. 26B is cut 90 degrees from FIG. 26C to better show the frame (113), rollers (142) and motor (116).

In the embodiment shown in FIGS. 26A, 26B, 26C, 26D, 26E and 26F, four roller rods (139) are used with four concave rollers (142) per gyro flywheel moving frame box (123). A tee adapter and connector (141) is utilized to attach the roller rods (139) to the disk connecting rods or spacers (124). Each roller wheel (142) has a shaft (140). The roller wheels (142) have a concave shape that fits the rods (139), thus maintaining the correction position and alignment as the gyro motor and flywheel move in and out, and allowing an easy in and out motion. A motor mount (169) keeps the motor (116) securely in position. A hub (143) is utilized for attaching the bearing to the disk (4). Each roller wheel (142) has a shaft (140). Only one limit switch (144) is required for each direction (in or out), since turning the screw drive motor (116) off with the one switch (144) will allow the stopping position of each gyro flywheel to be identical. Controls will be needed for restarting the drive motor (116) in the opposite direction for the next engagement after a limit switch has deactivated the drive motor. FIG. 26D shows the motor (1) with a clamp (166) and bolt (167). The component (57) is stackable, as previously described, etc. for other units. The screw gear shaft motor (116) can be replaced with a gear motor unit.

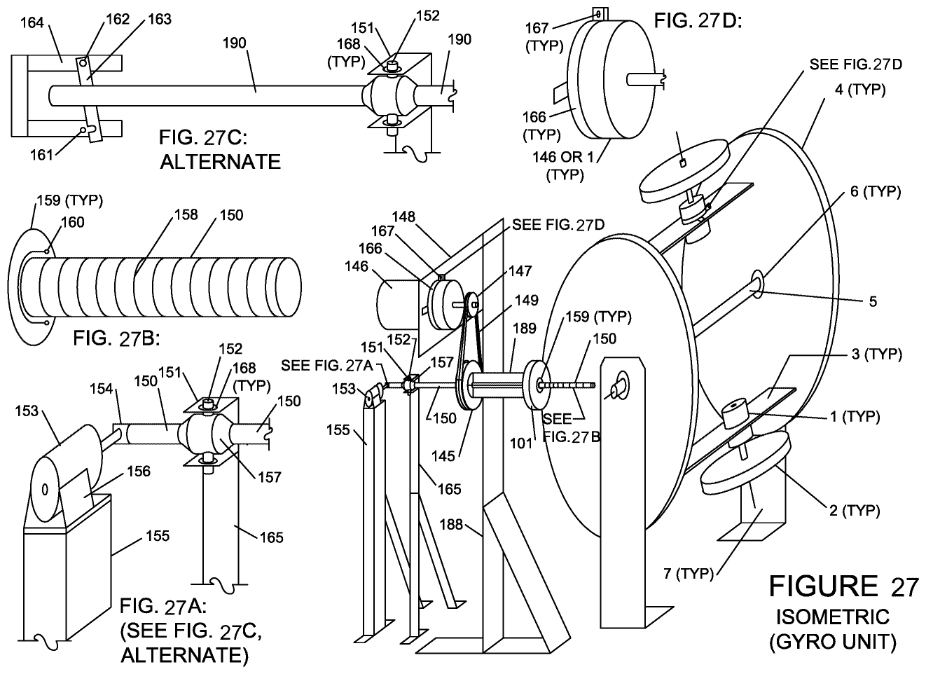

Referring to FIG. 27, the cart is not shown for clarity. (Refer to other figures for the cart drawings.) This figure illustrates another arrangement for small applications wherein a combination of rubber wheel drives (101) can be used. A drive motor (146) drives the rubber drive wheel (101) by a pulley system with a smaller pulley (147), a larger pulley (145) and a connecting belt (149). This drive motor (146) can be replaced with an optional gear reduction motor unit. An energized solenoid motor (153) keeps the rubber wheel (101) pressing upon the outer disk (4) of the assembly wheel. It is connected to a swivel/slide type joint (154), which is attached to the lever and shaft (150). The solenoid motor (153) is used for an on/off position for the rubber drive wheel (101). The rubber wheel (101) is slightly compressible for good traction results with adequate applied pressure. A de-energized solenoid (153) will allow the internal spring to push out the connection point (154) and will move the lever (150) and therefore the rubber wheel (101) will be pulled away from the assembly wheel disk (4). (The solenoid motor (153) has an internal spring.) The pin shaft connection (152) with a top and bottom bearing (168) is located in an enlarged joint section (157) of the lever rod (150). A framing support (188) for the drive motor is required to make a stand at the proper elevation with a cross piece (148) for the motor (146) support. Two rubber wheels (101) can be used, one on each disk wheel (4) or one on each side will make the pressure force offset each other. Therefore, the effective force on the assembly wheel bearings (6) will be zero. Only one lever and rubber wheel mechanism is shown for clarity. Different positions on the lever (150) for the rubber wheel (101) are possible for different gear ratios, as the rubber wheel (101) contact location and drive radius on the assembly wheel disk (4) is changed. The rubber wheel (101) and the larger pulley (145) are connected by a spacer (189) with a bearing (159) on each end. One bearing is for the large pulley (145) and one for the rubber wheel (101). The lever shaft/arm (150) does not rotate. The connected and rotating spacer (189) allows the drive motor (146) and pulley (147) to be located at a reasonable position away from the disk (4). Alternate FIG. 27C includes an alternate in lieu of the shorter lever arm (150) for a manual lever (190) with a latch bolt (161) with wing nut and a pin (162) with lever (163), to hold the engaged position of the rubber wheel (101). The arm length of the lever (190) is longer to facilitate an easier way to apply good pressure on the face of the disk (4). FIG. 27A is an enlarged drawing of the solenoid motor (153) and shows a bearing (168) for the pin shaft (152) for the joint (157). The bearing (168) and pin (152) are present both on top and bottom of the joint (157) to allow for a good swivel motion. FIG. 27B is an enlarged drawing of the lever (150) showing the bearings (159), a snap ring retainer (160) and the shaft grooves (158). This arrangement allows the adjustment of both pulleys to move the same amount for the position adjustment so that the belt (149) remains in good alignment. Multiple grooves (158) are shown for the larger pulley (145) adjustment and rubber wheel (101) position. This allows a different manual adjustment for the disk radius position. Two snap rings (160) are required, one for the pulley end (145) and one for the rubber wheel end (101). Also the drive motor or gyro motor (1 or 146) position is adjusted similarly by a motor clamp type support (166) and bolt (167). (See FIG. 27D.) Arrange motor (146) in a position so that when the rubber drive wheel is engaged, the belt tension is tight with good alignment. Therefore, the large pulley (145), rubber wheel (147) and belt (149) will all be positioned at the proper belt tension. The speed of the assembly wheel (8) will be changed, since there is a different gear ratio for each radius position on the face of the disk (4). Alternately the RPM speed of the drive motor (146) can be changed by a VFD (variable frequency drive) control system. FIG. 27D is an enlarged drawing of the drive motor (146) and clamp (166) with bolt (167) which allows the drive motor (146) to move in or out for the speed adjustment as per above. When two mechanisms with two rubber wheels (101) are used with two drive motors (146), the drive motors (146) can be one half the size of a single drive motor (146), since the application is additive for each motor (1 or 146). One drive motor (146) is clockwise and the other is counterclockwise with the motor leads reversed. The framing components can include the additional parts (151, 155, 156, 164, and 165) that are shown and identified. As mentioned previously, part numbers (1, 2, 3 and 5) are shown and identified. This system could be easily automated further with a splined shaft in replacement of the grooves (158) on the shaft (150) for the rubber wheel (101) and the larger pulley (145) and for the motor mount (148 and 166) also, with a lever mechanism for moving these components.

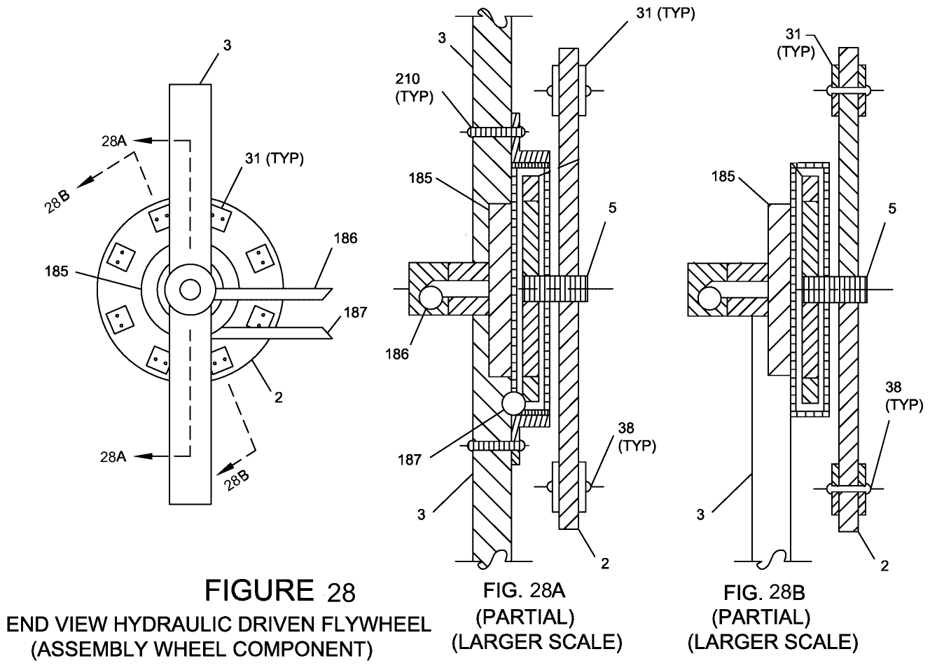

In FIG. 28, a hydraulic motor drive system is shown as an alternate drive for the flywheels. A hydraulic motor (185) is used with two pipes, the inlet (186) and the outlet (187). The outlet (187) is piped to a return system. The inlet (186) is connected to supply pressure piping. A swivel joint (26) is used for both the supply and return of hydraulic fluid. See FIG. 5 for the swivel joint piping with parts (26, 27, 28 and 109) shown. A pipe connection to a hollow shaft (27, see FIG. 5A) is used for both connections, one on each end of the assembly wheel through the hollow shaft (27) to the inside of the gyro assembly unit for hydraulic fluid supply and return flow. Two short hollow shafts (27) with hub connections (143, see FIGS. 10 and 11) are used, one on each end of the assembly wheel unit. (See FIG. 26B.) Attachment hardware can include bolts or rivets (38 and 210). As mentioned previously part numbers (2, 3, 5 and 31) are shown and identified.

FIG. 29 shows the alternate FIG. 3 assembly wheel components (57) stacked for multi-row type gyro assemblies (8). The gyro flywheels are lined up since the angular positioning already includes an inherently balanced assembly wheel. The angular positioning and rotation order is important and is described elsewhere. FIG. 29A shows a motor (1) with a clamp (166) and bolt (167). The framing components can include the additional parts (7 and 177) that are shown and identified. As mentioned previously, part numbers (2, 3, 4, 5, 6, 8, 9, 10, 11, 12, 13 and 21) are shown and identified.

For any of the assembly wheel unit embodiments shown in the figures (See FIGS. 1, 2, 10, 11, 13, 20, 23, 24, 25, 27, and 29) a control system controls the speed of the internal DC or AC gyro flywheel motors (1) by controlling the feeder voltage, frequency or the current flux. Likewise, the internal gyro flywheel turbines (32) or hydraulic motor unit (185) (see FIGS. 7 and 28) can utilize the difference in pressure or flow for speed control. Likewise the internal engine driven flywheel units (29 and 97) can control the fuel flow (see FIGS. 6 and 18). Other control systems demonstrated for the internal gyros are the variable radius options (see FIGS. 21 and 26). Due to the equations, both these methods will serve to modulate the result force. These options can allow a constant speed drive motor system for parts (9, 102, 146, 191 and 213).

For all of the above figures that include the gear motors with part numbers (9, 17 or 213), any of the gear motors can be replaced with a standard full speed motor, and any gear reduction can be accomplished by gears or pulleys. The effective RPM speed of the shaft output can be controlled by various methods, such as VFD, for either the normal speed motor or the slower gear motor. Likewise the standard motors (74, 116 or 146) can be replaced with gear motor units.

Material of construction: The metal parts can be the shafts, pulleys, flywheel weights, threaded plates, gear screw shaft, reels, springs, bolts and nuts, tire rims, and others. For some applications requiring light weight, much more strenuous designs will be required to ensure total weight is keep to a minimum. For example, many plastic parts could be utilized that are normally metal. Other parts can also be light-weight wood. Motors, engines, controllers can be normal shelf items.

The gyro motion unit comprises the following variations and illustrative embodiments. These and other embodiments will be apparent to those skilled in the art based on the detailed description provided.

In one embodiment, a disk assembly has a pair of opposing flywheels and said flywheels rotating about a first longitudinal axis. First and second motors are provided and the flywheels rotate as if rotating on the same shaft, though not necessarily in the same direction (CW or CCW). (See FIG. 1.)

First motors connect to each flywheel for separate rotation of each flywheel, wherein in each disk assembly one flywheel is opposed in rotation from the other when looking from the outside towards the center of the unit; or as noted above on the same single axis. First and second motors are provided. (See FIG. 1.)

Next a unit assembly is provided comprising at least one disk assembly component and being rotatable about a second axis. A third motor unit is provided, which can be a gear motor unit or a standard motor unit. The drive motor unit can be a variable speed motor, to control the total reaction force, which would control the total “Reaction Force” for each gyro assembly unit. This would control the forward speed of the craft. A variable frequency drive “VFD” system can be used to control the speed of the drive motor unit, the third motor unit. (See FIG. 1.)

The drive motor, third motor, connects to the unit gyro assembly for rotation of the unit gyro assembly. This drive system is for the main usable “Reaction Force” to push the entire unit forward, etc. This utilizes the principle of a reaction force for moving an energized gyro flywheel, but the assembly wheel makes it mechanized and it is continual. (See the discussion of the precession speed, elsewhere.) A pair of gyro flywheels is utilized for a perfect dynamic weight balance of each gyro assembly unit and the pair is required for the reaction force. (See FIG. 1.) A further discovery during experimentation is that three gyro flywheels mounted in the assembly wheel will not produce the reaction force desired. This is the reason that the gyro flywheels are shown as pairs in all of these designs and embodiments. Also a specific rotation for each pair is required.

The first arrangement of multiple flywheel pairs is simple. The components with the gyro flywheel pairs are lined up and all have the same rotation. The 0 degree flywheels would be CCW and the 180 degree flywheels would be CW in all the components. The assembly wheel with multiple rows (lined up rows) will have an additive reaction force for each pair. (See FIG. 1.)

Second is a staggered pair arrangement. The specific rotation for staggered multiple pairs is essentially the same for two cases. The arrangement can be multiple components stacked as rows. (Very similar to FIG. 1.) Alternatively, the arrangement can be a single component with a larger radius with multiple gyro flywheel pairs. (See FIG. 3.) The gyro flywheel pairs are numbered as per the rotation of the assembly wheel, CCW. The first gyro rotates CCW. Then each sequential flywheel rotates CCW, such as 0 degrees, 45 degrees, 90 degrees and 135 degrees. Then the next flywheel is an opposite pair of one of the above, so the rotation would be CW for the flywheel at the position of 180 degrees, 225 degrees, 270 degrees, and 315 degrees. Therefore, the assembly wheel has an additive reaction force for each of the multiple staggered pairs. Therefore the gyro pairs can be stacked and staggered in a row or staggered inside a single component. (See FIG. 29.)

An alternative to the VFD control system is a magnetic drive coupling to control the speed of assembly wheel unit driven by the unit drive constant speed motor, third motor. (See FIG. 12.)

One simple power system is on-board batteries or fuel tanks inside the gyro assembly for the flywheels. The unit can utilize exterior fuel tanks or batteries for the other motors and for the other power needs. (See FIGS. 6 and 22.)

A power delivery system will provide input power for rotation of the flywheels and the unit assembly in lieu of on-board batteries or fuel tanks inside the gyro assembly. Several power delivery systems and variations include: a Fuel delivery system with a swivel joint and a hollow shaft through the disk of the assembly wheel (see FIG. 5); an electric delivery system with brushes and rings on the flywheel for a normal higher voltage AC system (see FIG. 4); likewise the external motors (part no. 9, etc.) can be normal higher voltage AC systems. (A generator could be utilized as well for a DC system.)

An alternate design in lieu of separate gyro motors and flywheels above is a single double ended motor, first motor, with a single crossing shaft or axle. The shaft connects across the two flywheels to energize the pair. Proper flywheel rotation is achieved automatically, and one of the flywheel motors is eliminated. (See FIG. 10.)

In addition, the single shaft or axle above can be connected by a power driven gear or pulley and driven by the first motor, and the second motor is eliminated. (See FIG. 11.)

Another steering motor connection to the gyro assembly frame is geared down with controlled rotation and for angular directional positioning of the unit, wherein a fourth motor unit is provided. This rotates/turns the gyro assembly unit frame and likewise the “Reaction Force” will turn and very effectively provide steering for the craft. (See FIG. 2.) This unit can be a gear motor unit or a standard motor unit.

Power can be fed into the rotating assembly for the gyro flywheel motors, in lieu of batteries for each motor. This can be done by a special brush and spring unit for both the positive and negative connections. Wiring each motor opposite is then accomplished. The power feeder rotating connection consists of two separate rings, one larger in diameter. The rings are mounted onto the disk on one side. With first and second motors arranged accordingly, a brush set makes contact with each ring of the leads, negative and positive similar to motor armature brush set, except flat rings like washers, suitable for the disk's flat surface. (See FIG. 4.)

An alternate design of above can have one ring with brush and spring on one disk and the other ring, etc. on the other disk at the opposite end. These can use the same sized rings.

Reversing motors can be used for applying brakes to the unit while in a forward motion for any type of vehicle, wherein a third motor is used. When the assembly drive motor is reversed in direction from CCW to CW, the “Reaction Force” is reversed in direction. (See FIG. 1.)

For control, all motors can be of variable speed, starting with the assembly drive motor (third motor), then the steering motor (fourth motor, etc.) then the gyro flywheel motors (first and second motors). It is expected that the gyro flywheel motors, first and second motors, would be configured for constant speed in most design cases. The drive motor (third motor) speed controls the magnitude of the total forward force. Tilting sensors can connect into a central controller for the crafts so that each gyro assembly wheel is appropriately controlled. An optional rudder can be controlled manually by a normal mechanism. But the stabilizing gyro, which is similar to a helicopter stabilizer rotor, would be connected to the central controller.

In another embodiment, smaller gyro assemblies can be used to counteract the overturning force of high speed truck trailers. These can be electrically powered or use some PTO (power take off mechanism) developed later. (See FIG. 25.)

In lieu of the electric motors, regular combustion engines can be utilized. The two gyro flywheel motors and the drive motor can be replaced with combustion engines for power. These can be variable speed or constant speed. It is expected that the speed for the gyro flywheels would remain constant. For a pair of gyro flywheels, one engine would rotate CCW and the other CW. Small 2-cycle model airplane engines do this now without any problems, and so larger ones could be built. It is expected that the steering motors, i.e. the fourth engine driver, would remain electric. (See FIG. 6.)

Larger UAV (Unmanned Aerial Vehicle) 2 cycle engines now can be ordered with CCW and CW rotations. These engines are operated now at constant speed, set after start-up. These UAV engine/generator units could be utilized as the drive units for onboard generators and for assembly wheel drive units in combination with gear reducers. The DC generator drives the gyro flywheel DC motors and charges a battery system. On board fuel tanks can be utilized for a ballast system and serve a double function.

A fuel swivel joint connection system at the disk on the assembly wheel can be used for the fuel connection to the gyro engines as per above and power the first and second engine drivers. (See FIG. 5.)

In the future, larger 2 cycle engines will likely be developed that run slower, and can be utilized for the drive system for the gyro assembly wheel unit. Any position for mounting is possible since the oil and gas are mixed. This would help with the gear reduction needed.

In the future, other standard or higher speed 2 cycle engines will likely be developed that can be utilized inside the assembly wheel, which will be rotating at the RPM speeds needed, but normally constant speed. The 2 cycle engines can run and be mounted on a disk wheel that is rotating. (See FIG. 6.) This is possible since the oil and gas are mixed (as normal for 2 cycle engines), and the fuel is supplied by the special designs. A fuel pump may be needed, and can be any inline type connected to an exterior fuel tank system. For interior mounted fuel tanks, the centrifugal force will provide adequate force for fuel delivery. Special design for the delivery line exit point is an easy modification for the interior tanks, similar to existing model airplane tanks used on circular line models. Fuel tanks can be pressurized by the vent line from an exhaust muffler. Fuel pumps can also be provided.

The gyro flywheels can be energized or powered by a turbine. The turbine for comprising the first and second turbine engine drivers for the flywheel pair can be vacuum, steam and condensate, or positive air pressure driven. (See FIG. 7.) Similarly, the hydraulic motor drive is also shown and described. (See FIG. 28.)

Spherical rollers for the flywheels allow the flywheels to be a very large size. The spherical roller prevents excessive wobble for the large size flywheels. The roller assembly connects to the flywheel by tube and piston with springs inside. The rollers are to ride in a trough hoop that is larger than the flywheel, and that is mounted to the assembly disk as a guide for the spinning flywheels. The weight of the rollers acts as weight for the flywheel, so that the total rotational inertia is adjusted for the added weight and radius. The weights of the flywheel can be reduced for this design, since the rollers are accumulative for the total flywheel rotational inertia weight. Therefore calculation to determine the amount, size and flywheel weights will be required. The flywheel weights can be eliminated by careful design. This should benefit the total system. (See FIG. 9.)

Several alternate methods are considered in the embodiments herein to prevent excessive wobble. One alternative is to attach regular hard flat type rollers onto the flywheel. These rollers ride on an outside sleeve, mounted as per above sleeve trough. (See FIG. 8.)

Another alternative from above is the arrangement of simple sleeves of thin sheets mounted as per the previously mentioned sleeve trough. The sleeve is positioned just on the outside of the flywheels. The outside edge of the flywheels can have a low friction mechanism such as Teflon™, Nylon™ or oil impregnated skid knobs mounted. A very slight gap is to be provided. An occasional rub is expected. (See FIG. 16.)

With regard to the additive aspect of the gyroscopic motion machine, several embodiments are provided within the scope of the device. First, rows of gyro pairs can be added for the same gyro assembly, providing multi-row units. This arrangement adds power to the reaction force or push. Different arrangements are possible. The first option is a lined up arrangement with all CCW gyro flywheels at 0 degrees and all CW gyro flywheels at 180 degrees initially. (See FIG. 1.)

In a second option, a staggered arrangement is provided. It must be done in a particular order. For a four pair unit, the flywheels must be arranged in an angular order, starting with 0 degrees, then add 45 degrees, then 90, then 135 degrees. These flywheels would have a CW rotation. Then the flywheels starting with 180, then 225, then 270 and 315 degrees are to have CCW rotation. This allows a pair at the sets (0, 180) on one row and likewise (45, 225), (90, 270) and (135, 315). The rotation motion is smoother, since the gyros are arranged around the circumference. Many more rows are possible. Also dynamic balanced assembly wheel units are smoother and easier for longer bearing endurance. (FIG. 1 shows a 0 and 180-degree line up arrangement, but the above is not shown.)

As per the second option above having a staggered arrangement, a similar arrangement is a much larger assembly wheel with more spacing to allow all the gyro flywheels and motor to be arranged in the staggered positions. The same pair arrangement as per above is to be utilized, maintaining the proper order and rotation. (See FIG. 3.)

For single pair ground units only, additional weight matching the flywheels and motors can be added on each assembly at 90 degree opposites, such as for gyro pairs at 0 degrees and 180 degrees, and weights can be added at 90 degrees and 270 degrees. This makes the rotation smoother with much less tendency to get out of balance, and the bearings, etc. have longer endurance. (See FIG. 23.)

In lieu of gears or pulleys for the gyro assembly drive, a rubber friction wheel can be used, similar to a shift on the fly drive system used on some lawn mowers. A motorized or energized rubber friction wheel with spring pressure rides on the disk surface. It can be moved in or out manually for speed control for a shift on the fly by operating in connection with the third motor. (See FIG. 20.) This design does not allow for a shift on the fly but merely provides a constant speed drive that is manually adjustable during a shut down. A shift on the fly mechanism would be an obvious improvement. A similar and more powerful drive system which utilizes the rubber friction wheel is included. It has a stand mounting frame for the motor swivel mechanism. The design allows the swivel motion with the pressure applied for friction, etc. (See FIG. 27.)

I claim:

1. A gyroscopic motion machine comprising an arrangement of:
at least one assembly wheel component, comprising a pair of parallel spaced frames which are joined by a plurality of cross-braces connecting the said frames, and within which at least one flywheel pair is mounted on a pair of cross-braces within said assembly wheel component, wherein each flywheel pair comprises one first flywheel positioned on a first shaft on a first cross-brace which is situated on said assembly wheel component 180 degrees diametrically opposed to one second shaft upon a second cross-brace, upon which second shaft a second flywheel is situated, and wherein the position, mass and shape of said flywheel pair is symmetrical by design for rotational dynamic balance of both the said flywheel pairs and the said assembly wheel component;
at least one motor (herein called a gyro motor), wherein each individual flywheel of a said flywheel pair is directly coupled to a said gyro motor for rotationally driving one or more flywheels of the flywheel pair, and wherein said first flywheel is driven counterclockwise and said second flywheel is driven clockwise to create a continuous motion of the flywheel pair;
an assembly wheel unit formed by one or more of the said stackable assembly wheel components;
a drive motor or drive gear motor connected to said assembly wheel unit for rotation of said assembly wheel unit;
a power source arranged to deliver power to each said gyro motor and to said drive motor or drive gear motor;
a moveable object with at least one space for mounting the one or more said assembly wheel units, motors and power source;
at least one shaft for mounting the said assembly wheel components on said moveable object with at least two bearing connections and supports, configured for dynamic rotational balance; and
two support thrust bearings for each said assembly wheel component shaft, and two support brackets are located with one on each end of the said assembly wheel component shaft to allow said assembly wheel component to rotate smoothly and to allow the thrust force transmission from the assembly wheel to the said moveable object.

2. The gyroscopic motion machine of claim 1, additionally comprising at least one of:
a single double ended gyro motor and single flywheel pair wherein each flywheel is indirectly coupled through a power belt mechanism to the said double ended gyro motor, which double ended gyro motor is offset from the said flywheel shafts, and said double ended gyro motor drives said first flywheel counterclockwise and drives said second flywheel clockwise;
a plurality of said flywheel pairs, wherein each said flywheel pair is equally spaced from each other said flywheel pair;
a plurality of said assembly wheel components, which-are stacked in a row within the said assembly wheel unit and all of the said assembly wheel components are connected and rotated by the said drive motor or drive gear-motor;
a plurality of said flywheel pairs which are aligned in a plurality of straight-line rows within the said assembly wheel unit;
a plurality of said flywheel pairs that are equally spaced in equidistant angular displacements with respect to each said flywheel pair within each said assembly wheel component;
a plurality of weights mounted on the said assembly wheel component frames at 90 and 270 degrees to further assist with the rotational balance of the said assembly wheel component, wherein the said first flywheel is relatively positioned at 0 degrees on said assembly wheel component frames, and the said second flywheel is relatively positioned at 180 degrees on said assembly wheel component frames;
a single gas or diesel double ended gyro motor for each said flywheel pair, which double ended motor is mounted within the said assembly wheel component and which double ended gyro motor is coupled to the flywheel pair for counterclockwise rotation of said first flywheel and clockwise rotation of said second flywheel;
said drive motor or drive gear motor is a combustion engine;
a fluid gas or liquid delivery system from outside the said assembly wheel unit to inside the said assembly wheel unit for supplying fuel or other types of hydraulic fluids to the said motor;
the said drive gear-motor having built in gear reduction;
the said drive motor or drive gear-motor being coupled through a gear mechanism to the said assembly wheel unit;
for each said flywheel, a second cross-brace and an external magnetic bearing connecting said second cross-brace to said shaft extending from each said flywheel to prevent wobble;
the said drive motor or drive gear-motor being coupled through a magnetic coupling to said assembly wheel unit, and said drive motor or drive gear motor having variable speed output capability;
one or more fuel tanks mounted inside of the said assembly wheel unit, providing fuel to said gyro motors;
said power source comprising batteries which are mounted inside of the said assembly wheel unit;
a variable speed controller connected to said drive motor or drive wheel motor to modulate the said drive motor's RPM speed; or
a variable speed controller connected to one or more of said gyro motors to modulate the said motor's RPM speed.

3. The gyroscopic motion machine of claim 1, further comprising a swivel mount connecting said assembly wheel unit to said moveable object; and a rotational power driving mechanism connected to the said drive motor, which drive motor has a reversing capability.

4. The gyroscopic motion machine of claim 1, wherein each said gyro motor comprises a fluid turbine drive system, which is mounted within each said assembly wheel component, and wherein the said fluid drive system comprises at least one of:
an air gas pressure system and driver;
an air gas vacuum system and driver without supply, only return;
a steam vapor or other chemical element gas supply pressure system and driver with condensate liquid fluid return;
a hydraulic oil or other liquid fluid pressure system and driver with return;
a water liquid fluid pressure system and driver with return;
a glycol and water solution or other antifreeze solution liquid fluid pressure system and driver with return;
a vapor gas supply pressure and driver with either vapor gas fluid return or condensed liquid fluid return; or
a liquid fluid pressure system and driver with return.

5. The gyroscopic motion machine of claim 1, in which each said flywheel is fitted with a mounting center hole connection for its said shaft, and where each said flywheel comprises an arrangement of at least one of:
a rim wheel, with two surfaces and an outer edge which defines said flywheel's circumference, wherein the said outer edge or surface near said outer edge is (rim) loaded with weights attached about the said outer edge or on a surface near the said outer edge-of said flywheel;
a spoked rim wheel, with an outer edge which defines said flywheel's circumference, wherein the said outer edge is (rim) loaded with weights attached about the said outer edge of the said spoked rim wheel;
a simple symmetrical round disk with or without holes;
a simple symmetrical round disk with two surfaces and an outer edge which defines said flywheel's circumference, wherein the said outer edge or surface near said outer edge is (rim) loaded with weights which are equally spaced and attached about the said outer edge-of the said flywheel;
three or more bearing members added to the outside edge of each flywheel and said bearing members engage the outside edge of the flywheels and members are equipped with rollers on the outer parts of the members that roll along an outside positioned sleeve or band, in which members may be fitted with springs to cause the rollers to exert some pressure on the sleeve or not fitted with springs, and where rollers may be soft rubber for compression, whereby the bearing members stabilize the flywheels to prevent wobble, since the pressure on the flywheel perimeter restricts the flywheel wobble movement but allows rotation;
a hub with multiple lines extending from the hub and spherical weights attached to each line on a distal end from the hub; and
a plurality of equally radially spaced skid knobs on an outer rim of a disk with an outside positioned radial sleeve or band, where both the said knobs and said radial sleeve are suitable for minimal friction, whereby the clearance between said knobs and said radial sleeve is minimal but have an occasional touch with a rotational slide on the sleeve which prevents excessive wobble.

6. The gyroscopic motion machine of claim 1, further comprising at least one of:
said drive motor being coupled to a pair of rubber drive wheels, which rubber drive wheels in turn engage one of the said frames of the said assembly wheel component by spring pressure; or
said drive motor being coupled via a pulley system with a rubber drive wheel, said pulley system comprising a small pulley, a large pulley and a connecting belt, a solenoid motor is connected to the rubber drive wheel, the drive motor is further connected to a slide joint and the slide joint is attached to a lever and shaft, and said lever is attached to said rubber drive wheel.

7. The gyroscopic motion machine of claim 1, further comprising a variable radius gyro flywheel positioning system for the said assembly wheel component, while optimizing and maintaining dynamic balance and symmetrical configuration in design, including an arrangement of at least one of:
a positioning shaft for movement of both of the said flywheels of each said flywheel pair equally in and out for adjustment distance between the said flywheels, resulting in a variable radius positioning mechanism;
a reversible motor to move said flywheels in and out on said positioning shaft for flywheel radius adjustment;
limit switches for automatic shut off;
guide tubing sections for moving the said flywheels in and out;
rollers for the said guide tubing sections for moving the said flywheels in and out;
box structures for mounting and positioning for the said flywheels and the said gyro motors; or
wheels for each box structure for moving the said flywheels in and out.

8. The gyroscopic motion machine of claim 1, which is used as a stabilizer for truck trailers, freight trains or other tall vehicles, to prevent overturning on highway or railroad curves.

9. The gyroscopic motion machine of claim 1, in which the rotation of the assembly wheel may be reversed or suitably adjusted for braking to reduce unit horizontal motion speed, or in which optional separate gyroscopic motion machine units are being additionally provided and mounted that when power is supplied and these said gyroscopic motion machine units are turned on, their generated opposing force is effectively utilized for braking with speed reduction of the horizontal motion for any transportation unit which may include automobiles, motorcycles, bikes, trucks or trains, comprising an arrangement of at least one of:
additional multiple or single optional separate gyroscopic motion machine units are being additionally provided and mounted that when power is supplied and these units are turned on, their generated opposing force is effectively utilized for braking with speed reduction of the horizontal motion;
positioned for center of gravity;
positioned for downward force, for more traction;
positioned for perpendicular force for stability during hard slow downs; or
positioned for turning.

10. The gyroscopic motion machine of claim 1, wherein said power source-comprises an arrangement of at least one of:
an external storage battery system equipped with a generator and a battery bank storage system for a powerful DC system;
an alternator type power plant package unit for an alternating current electric power source;
multiple UAV (Unmanned Aerial Vehicle) type engines equipped with add on generators and a battery bank storage system;
system drive accessories including add on cooling fan (propeller type) blades mounted on the pulleys for the UAV engine or other type engine;
system drive accessories including a gear box for speed change for the assembly wheel driven by the UAV engine or other type engine driver;
system drive accessories including a magnetic coupling for the UAV engine or other type engine driver with variable speed output capability, whereby modulating the assembly wheel RPM speed and the output force of the gyroscopic machine unit; or
system drive accessories including fuel control for the UAV engine or other type engine driver, whereby modulating the assembly wheel RPM speed and the output force of the gyroscopic machine unit.

11. The gyroscopic motion machine of claim 1, further comprising a wiring and delivery system for voltage comprising an arrangement of at least one of:
a DC (direct current) delivery system with an external DC power source fed by power cables, supplied by a battery bank or other DC power source for the said gyro motors, which gyro motors are mounted inside the respective said assembly wheel components;
a DC battery bank or other DC power source mounted inside the said assembly wheel component for the said gyro motors, which said gyro motors are likewise mounted inside the respective said assembly wheel components;
an AC (alternating current) delivery system with an external AC power source fed by power cables, for the said gyro motors, which said gyro motors are mounted inside the respective said assembly wheel components;
an AC delivery system for the said drive motor or drive gear-motor;
a DC delivery system for the said drive motor or drive gear-motor; or
bronze, copper or other metal ring plates or other shaped contact surfaces with contact brushes mounted for continual contact during the rotation of the said assembly wheel component, for delivery of electric power to the inside of each said assembly wheel component for the gyro motors.
